(19) United States
(12) Patent Application Publication
(10) Pub. No.: US 2019/0071075 A1
(43) Pub. Date: Mar. 7, 2019

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventor: Yoshitaka MIMURA, Wako-shi (JP)

(21) Appl. No.: 16/084,257

(22) PCT Filed: Mar. 16, 2016
(86) PCT No.: PCT/JP2016/058363

§ 371 Date: Sep. 12, 2018

(51) Int. Cl. B60W 30/09; B60W 30/095; B60W 50/14; G06K 9/00

(52) U.S. Cl. CPC B60W 30/09; B60W 30/0956; B60W 50/14; G06K 9/00825; B60W 2550/304; B60W 2050/146; B60W 2550/10; B60W 2550/308; B60W 2550/302; G06K 9/00805

(57) ABSTRACT

A vehicle control system includes an output unit that outputs information, a recognition unit that recognizes nearby vehicles traveling around a subject vehicle, a control unit that controls acceleration/deceleration or steering of the subject vehicle on the basis of a relative positional relationship between at least some of the nearby vehicles recognized by the recognition unit and the subject vehicle, a specifying unit that specifies a nearby vehicle likely to influence the acceleration/deceleration or the steering of the subject vehicle among the nearby vehicles recognized by the recognition unit, and an output control unit that causes the output unit to output at least information on the presence of the nearby vehicle specified by the specifying unit.

### TECHNICAL FIELD

The present invention relates to a vehicle control system, a vehicle control method, and a vehicle control program.

### BACKGROUND ART

In recent years, research on a technology for automatically controlling at least one of acceleration/deceleration and steering of a subject vehicle so that the subject vehicle travels along a route to a destination (hereinafter referred to as automated driving) have been performed. In connection therewith, a traveling assistance device including an assistance start unit that starts assistance in lane change on the basis of an input from an input device, a detection unit that detects a relative distance and a relative speed between a subject vehicle and another vehicle, a calculation unit that calculates, with respect to the other vehicle, a collision risk when the subject vehicle changes lane on the basis of the relative distance and the relative speed detected by the detection unit, a first judgement unit that judges whether the lane can be changed on the basis of the relative distance, the relative speed, and the collision risk, a determination unit that determines a target space for changing lane on the basis of the relative distance and the relative speed when the first judgement unit judges that lane change cannot be performed, a second judgement unit that judges whether or not there is a space in which lane change can be performed in the target space, a setting unit that sets a target speed toward a lane change standby position when the second judgement unit judges that there is no space and sets the target speed toward a lane change possible position when the second judgement unit judges that there is a space, and a control unit that performs control so that a speed of the vehicle becomes the target speed is known (see, for example, Patent Literature 1).

### CITATION LIST

### Patent Literature

[Patent Literature 1] Japanese Unexamined Patent Application, First Publication No. 2009-078735

### SUMMARY OF INVENTION

### Technical Problem

However, in the related art, since a vehicle occupant of the subject vehicle is informed of all pieces of information on nearby vehicles (other vehicles) adjacent to the subject vehicle at the time of automated driving, the occupant of the vehicle may feel annoyed and may not be able to recognize important information.

The present invention has been made in consideration of such circumstances, and an object of the present invention is to provide a vehicle control system, a vehicle control method, and a vehicle control program capable of informing a vehicle occupant of a surrounding situation of a subject vehicle in an appropriate range.

### Solution to Problem

An invention according to claim 1 is a vehicle control system including: an output unit that outputs information; a recognition unit that recognizes nearby vehicles traveling around a subject vehicle; a control unit that controls acceleration/deceleration or steering of the subject vehicle on the basis of a relative positional relationship between at least some of the nearby vehicles recognized by the recognition unit and the subject vehicle; a specifying unit that specifies a nearby vehicle likely to influence the acceleration/deceleration or the steering of the subject vehicle among the nearby vehicles recognized by the recognition unit; and an output control unit that causes the output unit to output at least information on the presence of the nearby vehicle specified by the specifying unit.

An invention according to claim 2 is the invention according to claim 1, wherein the output unit displays the information so that an occupant of the subject vehicle can visually recognize the information, and the output control unit causes the output unit to display the presence of the nearby vehicle specified by the specifying unit in a state in which the relative positional relationship with the subject vehicle is maintained.

An invention according to claim 3 is the invention according to claim 1, wherein the specifying unit specifies a nearby vehicle approaching the subject vehicle among the nearby vehicles recognized by the recognition unit, as nearby vehicles influencing the acceleration/deceleration or the steering of the subject vehicle.

An invention according to claim 4 is the invention according to any one of claims 1 to 3, wherein the specifying unit specifies a nearby vehicle of which a time based on the relative position and speed relative to the subject vehicle is equal to or greater than a threshold value among the nearby vehicles recognized by the recognition unit, as nearby vehicles influencing the acceleration/deceleration or the steering of the subject vehicle.

An invention according to claim 5 is the invention according to any one of claims 1 to 4, wherein the specifying unit specifies a nearby vehicle on the basis of a priority according to a condition for specifying each nearby vehicle when a plurality of nearby vehicles influencing the acceleration/deceleration or the steering of the subject vehicle are specified.

An invention according to claim 6 is the invention according to claim 5, wherein the priority is set to be higher for a nearby vehicle present on a traveling path of the subject vehicle or a nearby vehicle directed to the subject vehicle.

An invention according to claim 7 is the invention according to any one of claims 1 to 6, wherein the control unit generates a trajectory of the subject vehicle on the basis of a relative positional relationship between the nearby vehicle recognized by the recognition unit and the subject vehicle, and controls the acceleration/deceleration or the steering of the vehicle on the basis of the generated trajectory, and the specifying unit specifies a nearby vehicle traveling near the trajectory generated by the control unit among the nearby vehicles recognized by the recognition unit, as a nearby vehicle influencing the acceleration/deceleration or the steering of the subject vehicle.

An invention according to claim 8 is the invention according to claim 7, wherein the output control unit may further cause the output unit to output information on the trajectory generated by the control unit.

An invention according to claim 9 is the invention according to any one of claims 1 to 8, wherein the output control unit causes the output unit to output the information on the presence of the nearby vehicle specified by the specifying unit when the nearby vehicle specified by the specifying unit is within a predetermined distance in a traveling direction of the subject vehicle with reference to the subject vehicle.

An invention according to claim 10 is the invention according to any one of claims 1 to 9, wherein the output control unit causes the output unit to output the information on the presence of the nearby vehicle specified by the specifying unit in an output aspect different from an output aspect in a case in which the nearby vehicle is within a predetermined distance in a traveling direction of the subject vehicle, when the nearby vehicle specified by the specifying unit is not within the predetermined distance in the traveling direction of the subject vehicle with reference to the subject vehicle.

An invention according to claim 11 is the invention according to claim 10, wherein the output control unit causes the output unit to output a first image obtained in a case in which the nearby vehicle specified by the specifying unit is imaged from a first viewpoint behind the subject vehicle, when the nearby vehicle specified by the specifying unit is within the predetermined distance in the traveling direction of the subject vehicle with reference to the subject vehicle, and to output a second image obtained in a case in which the nearby vehicle specified by the specifying unit is imaged from a second viewpoint located behind the subject vehicle relative to the first viewpoint, when the nearby vehicle specified by the specifying unit is not within the predetermined distance in the traveling direction of the subject vehicle with reference to the subject vehicle.

An invention according to claim 12 is the invention according to claim 11 further including an operation unit that receives an operation from an occupant of the vehicle, wherein the output control unit switches between the first image and the second image according to an operation received by the operation unit.

An invention according to claim 13 is the invention according to any one of claims 1 to 12, wherein the output control unit further causes the output unit to output information on content of control performed by the control unit in which an influence of the nearby vehicle specified by the specifying unit is reflected.

An invention according to claim 14 is the invention according to claim 13, wherein the output control unit causes the output unit to output information on content of control performed by the control unit continuously after causing the output unit to output the information on the presence of the nearby vehicle specified by the specifying unit.

An invention according to claim 15 is a vehicle control system including: an output unit that outputs information; a recognition unit that recognizes nearby vehicles traveling around a subject vehicle; a control unit that controls acceleration/deceleration or steering of the subject vehicle on the basis of a relative positional relationship between the nearby vehicle recognized by the recognition unit and the subject vehicle; a specifying unit that specifies a nearby vehicle considered when the acceleration/deceleration or the steering of the subject vehicle is controlled by the control unit; and an output control unit that causes the output unit to output at least information on the presence of the nearby vehicle specified by the specifying unit.

An invention according to claim 16 is the invention according to claim 1 or 15, wherein the output unit informs of the information so that an occupant of the subject vehicle can recognize the information.

An invention according to claim 17 is a vehicle control method including: recognizing, by an in-vehicle computer, nearby vehicles traveling around a subject vehicle; controlling, by the in-vehicle computer, acceleration/deceleration or steering of the subject vehicle on the basis of a relative positional relationship between at least some of the recognized nearby vehicles and the subject vehicle; specifying, by the in-vehicle computer, a nearby vehicle likely to influence the acceleration/deceleration or the steering of the subject vehicle among the recognized nearby vehicles; and causing, by the in-vehicle computer, the output unit outputting information to output at least information on the presence of the specified nearby vehicle.

An invention according to claim 18 is a vehicle control program causing an in-vehicle computer to execute processes of: recognizing nearby vehicles traveling around a subject vehicle; controlling acceleration/deceleration or steering of the subject vehicle on the basis of a relative positional relationship between at least some of the recognized nearby vehicles and the subject vehicle; specifying a nearby vehicle likely to influence the acceleration/deceleration or the steering of the subject vehicle among the recognized nearby vehicles; and causing the output unit outputting information to output at least information on the presence of the specified nearby vehicle.

### Advantageous Effects of Invention

According to the invention described in each claim, it is possible to inform the vehicle occupant of the surrounding situation of the subject vehicle in an appropriate range.

### BRIEF DESCRIPTION OF DRAWINGS

FIG. 1 is a diagram illustrating components of a subject vehicle M.

FIG. 2 is a functional configuration diagram centered on a vehicle control system 100, and is a functional configuration diagram of the subject vehicle M.

FIG. 3 is a configuration diagram of an HMI 70.

FIG. 4 is a diagram illustrating a state in which a relative position of a subject vehicle M with respect to a travel lane L1 is recognized by a subject-vehicle position recognition unit 140.

FIG. 5 is a diagram illustrating an example of an action plan generated for a certain section.

FIG. 6 is a diagram illustrating an example of a configuration of a trajectory generation unit 146.

FIG. 7 is a diagram illustrating a time to collision TTC between the subject vehicle M and a nearby vehicle.

FIG. 8 is a diagram illustrating an example of candidates for a trajectory generated by a trajectory candidate generation unit 146C.

FIG. 9 is a diagram in which the candidates for the trajectory generated by the trajectory candidate generation unit 146C are expressed by trajectory points K.

FIG. 10 is a diagram illustrating a lane changing target position TA.

FIG. 11 is a diagram illustrating a speed generation model when speeds of three nearby vehicles are assumed to be constant.

FIG. 12 is a diagram illustrating an example of a scene in which a trajectory is corrected.

FIG. 13 is a flowchart showing an example of a flow of a process of an HMI control unit 170 in an embodiment.

FIG. 14 is a diagram illustrating an example of a scene in which a front vehicle mA decelerates.

FIG. 15 is a diagram illustrating a first display aspect.

FIG. 16 is a diagram illustrating an example of a first image that is displayed on a display 82.

FIG. 17 is a diagram illustrating an example of a first image that is displayed consecutively after the first image illustrated in FIG. 16.

FIG. 18 is a diagram illustrating a second display aspect.

FIG. 19 is a diagram illustrating an example of a second image that is displayed on the display 82.

FIG. 20 is a diagram illustrating an example of a second image that is displayed continuously after the second image illustrated in FIG. 19.

FIG. 21 is a diagram illustrating an example of a scene in which a distance D becomes greater than a threshold value D_{Th}.

FIG. 22 is a diagram illustrating an example of a third image that is displayed together with the first image.

FIG. 23 is a diagram illustrating an example of a first image that is displayed when a monitored vehicle is a nearby vehicle crossing a subject lane from an adjacent lane.

FIG. 24 is a diagram illustrating an example of a first image that is displayed when a monitored vehicle is a nearby vehicle crossing a subject lane from an adjacent lane.

FIG. 25 is a diagram illustrating an example of a trajectory that is generated in a scene in which an obstacle OB is present in front of the subject vehicle M.

FIG. 26 is a diagram illustrating an example of an image that is displayed on the display 82 in the scene of FIG. 25.

FIG. 27 is a diagram illustrating an example of a first image that is displayed when the monitored vehicle is a vehicle considered at the time of lane change.

FIG. 28 is a diagram illustrating an example of a first image that is displayed when the monitored vehicle is a vehicle considered at the time of lane change.

FIG. 29 is a diagram illustrating an example of a scene in which a merging point is present in front of the subject vehicle M.

FIG. 30 is an example of a second image that is displayed when the merging point is specified by a specifying unit 146B.

FIG. 31 is an example of a second image that is displayed when the merging point is specified by a specifying unit 146B.

FIG. 32 is a diagram illustrating an example of an image displayed on an instrument panel.

### DESCRIPTION OF EMBODIMENTS

Hereinafter, embodiments of a vehicle control system, a vehicle control method, and a vehicle control program according to the present invention will be described with reference to the drawings.

### <Common Configuration>

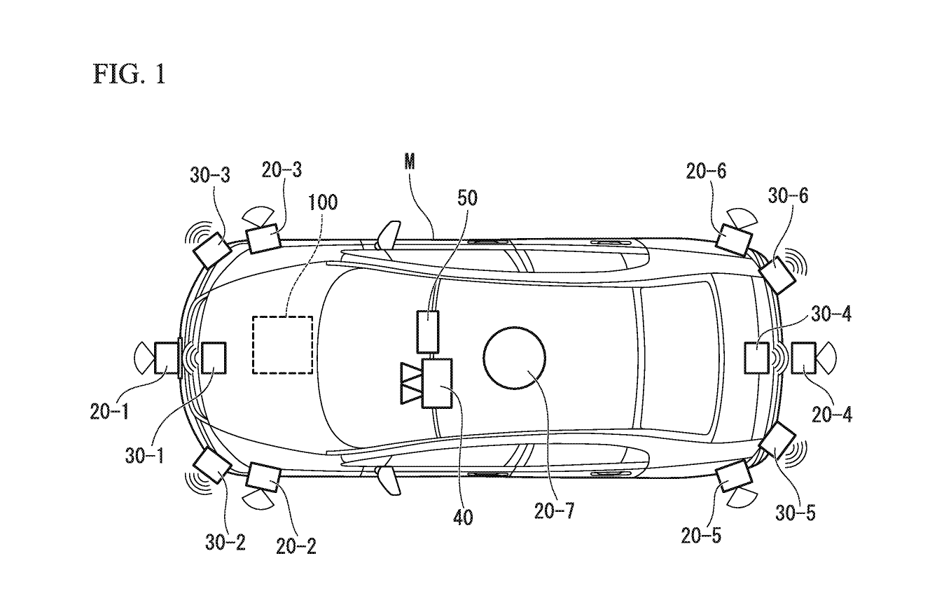

FIG. 1 is a diagram illustrating components included in a vehicle in which a vehicle control system 100 of each embodiment is mounted (hereinafter referred to as a subject vehicle M). The vehicle in which the vehicle control system 100 is mounted is, for example, a two-wheeled car, a three-wheeled car, or a four-wheeled car, examples of which include a car using an internal combustion engine such as a diesel engine or a gasoline engine as a power source, an electric car using an electric motor as a power source, or a hybrid car with an internal combustion engine and an electric motor. Further, the electric car is driven using electric power that is discharged by a battery such as a secondary battery, a hydrogen fuel cell, a metal fuel cell, or an alcohol fuel cell, for example.

As illustrated in FIG. 1, sensors such as finders 20-1 to 20-7, radars 30-1 to 30-6, and a camera 40, a navigation device 50, and the vehicle control system 100 are mounted in the subject vehicle M.

The finders 20-1 to 20-7 are, for example, light detection and ranging or laser imaging detection and ranging (LIDAR) finders that measure scattered light from irradiation light and measures a distance to a target. For example, the finder 20-1 may be attached to a front grille or the like, and the finders 20-2 and 20-3 may be attached to a side surface of a vehicle body, a door mirror, the inside of a headlight, the vicinity of side lamps, and the like. The finder 20-4 is attached to a trunk lid or the like, and the finders 20-5 and 20-6 are attached to the side surface of the vehicle body, the inside of a taillight, or the like. The finders 20-1 to 20-6 described above have, for example, a detection area of about 150° in a horizontal direction. Further, the finder 20-7 is attached to a roof or the like. The finder 20-7 has, for example, a detection area of 360° in the horizontal direction.

The radars 30-1 and 30-4 described above are, for example, long-distance millimeter-wave radars of which the detection area in a depth direction is wider than those of other radars. Further, the radars 30-2, 30-3, 30-5, and 30-6 are intermediate-distance millimeter wave radars of which the detection area in the depth direction is narrower than those of the radars 30-1 and 30-4.

Hereinafter, the finders 20-1 to 20-7 are simply referred to as a “finder 20” when not particularly distinguished, and the radars 30-1 to 30-6 are simply referred to as a “radar 30” when not particularly distinguished. The radar 30 detects an object using, for example, a frequency modulated continuous wave (FM-CW) scheme.

The camera 40 is, for example, a digital camera using a solid-state imaging element such as a charge coupled device (CCD) or a complementary metal oxide semiconductor (CMOS). The camera 40 is attached to an upper portion of a front windshield, a rear surface of a rearview mirror, or the like. The camera 40 periodically and repeatedly images, for example, in front of the subject vehicle M. The camera 40 may be a stereo camera including a plurality of cameras.

It should be noted that the configuration illustrated in FIG. 1 is merely an example, and a part of the configuration may be omitted or other components may be added.

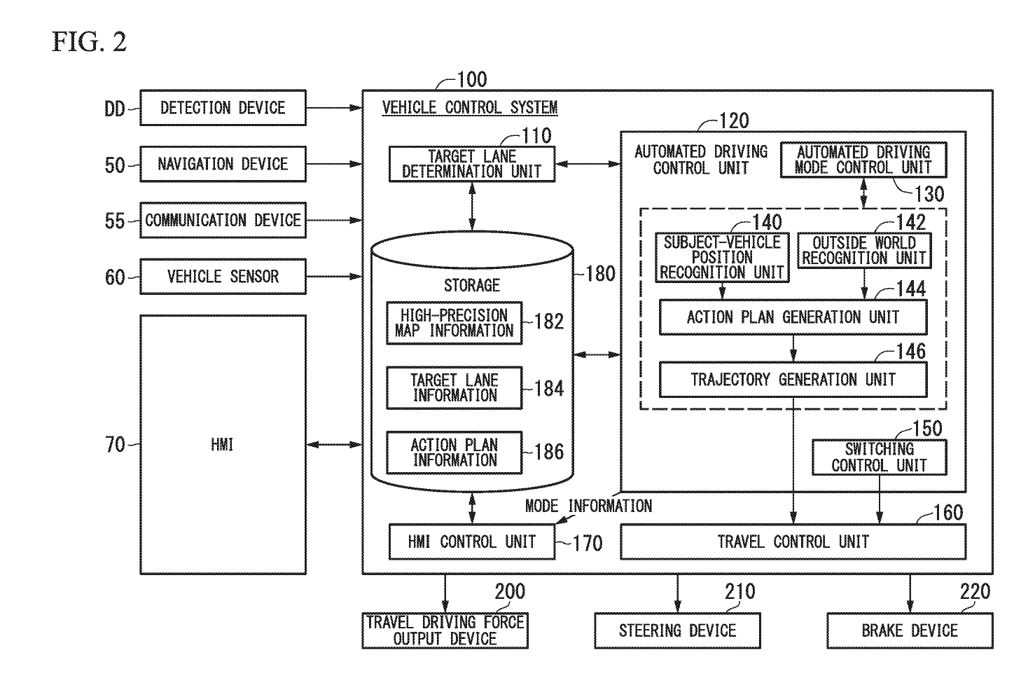

FIG. 2 is a functional configuration diagram centered on the vehicle control system 100 according to the embodiment. A detection device DD including a finder 20, a radar 30, a camera 40, and the like, a navigation device 50, a communication device 55, a vehicle sensor 60, a human machine interface (HMI) 70, a vehicle control system 100, a travel driving force output device 200, a steering device 210, and a brake device 220 are mounted on the vehicle subject M. These devices or instruments are connected to each other by a multiplex communication line such as a controller area network (CAN) communication line, a serial communication line, or a wireless communication network. It should be noted that a vehicle control system in the claims does not refer only to the “vehicle control system 100” but may include configurations (a detection device DD, the HMI 70, or the like) other than the vehicle control system 100.

The navigation device 50 includes a global navigation satellite system (GNSS) receiver or map information (navigation map), a touch panel type display functioning as a user interface, a speaker, a microphone, and the like. The navigation device 50 specifies a position of the subject vehicle M using the GNSS receiver and derives a route from the position to a destination designated by the user. The route derived by the navigation device 50 is provided to a target lane determination unit 110 of the vehicle control system 100. The position of the subject vehicle M may be specified or supplemented by an inertial navigation system (INS) using the output of the vehicle sensor 60. Further, the navigation device 50 performs guidance through speech or a navigation display for the route to the destination when the vehicle control system 100 is executing the manual driving mode. It should be noted that a configuration for specifying the position of the subject vehicle M may be provided independently of the navigation device 50. Further, the navigation device 50 may be realized, for example, by a function of a terminal device such as a smartphone or a tablet terminal possessed by the user. In this case, transmission and reception of information is performed between the terminal device and the vehicle control system 100 through wireless or wired communication.

The communication device 55 performs wireless communication using, for example, a cellular network, a Wi-Fi network, Bluetooth (registered trademark), dedicated short range communication (DSRC), or the like.

The vehicle sensors 60 include, for example, a vehicle speed sensor that detects a vehicle speed, an acceleration sensor that detects an acceleration, a yaw rate sensor that detects an angular speed around a vertical axis, and a direction sensor that detects a direction of the subject vehicle M.

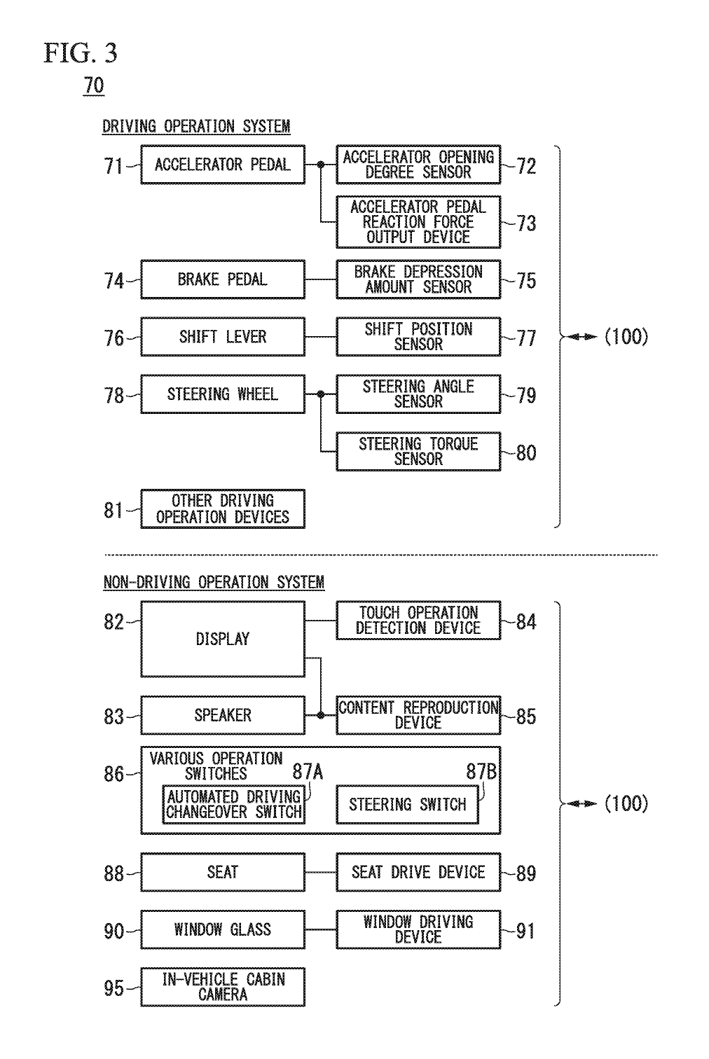

FIG. 3 is a configuration diagram of the HMI 70. The HMI 70 includes, for example, a configuration of a driving operation system and a configuration of a non-driving operation system. A boundary therebetween is not strictly defined, and the configuration of the driving operation system may have a function of the non-driving operation system (or vice versa). The HMI 70 is an example of an “output unit”.

The HMI 70 includes, for example, an accelerator pedal 71, an accelerator opening degree sensor 72, an accelerator pedal reaction force output device 73, a brake pedal 74, a brake depression amount sensor (or a master pressure sensor or the like) 75, a shift lever 76, a shift position sensor 77, a steering wheel 78, a steering angle sensor 79, a steering torque sensor 80, and other driving operation devices 81 as the configuration of the driving operation system.

The accelerator pedal 71 is an operator for receiving an acceleration instruction from the vehicle occupant (or a deceleration instruction according to a return operation). The accelerator opening degree sensor 72 detects the amount of depression of the accelerator pedal 71 and outputs an accelerator opening degree signal indicating the amount of depression. It should be noted that the accelerator opening degree sensor 72 may directly output the accelerator opening degree signal to the travel driving force output device 200, the steering device 210, or the brake device 220 instead of outputting the accelerator opening degree signal to the vehicle control system 100. The same applies to configurations of other driving operation systems to be described below. The accelerator pedal reaction force output device 73 outputs a force (an operation reaction force) in a direction opposite to an operation direction with respect to the accelerator pedal 71 to the vehicle control system 100 in response to an instruction from the vehicle control system 100, for example.

The brake pedal 74 is an operator for receiving a deceleration instruction from the vehicle occupant. The brake depression amount sensor 75 detects the amount of depression (or a depression force) of the brake pedal 74 and outputs a brake signal indicating a detection result to the vehicle control system 100.

The shift lever 76 is an operator for receiving an instruction to change a shift stage from the vehicle occupant. The shift position sensor 77 detects a shift stage instructed by the vehicle occupant and outputs a shift position signal indicating a detection result to the vehicle control system 100.

The steering wheel 78 is an operator for receiving a turning instruction from the vehicle occupant. The steering angle sensor 79 detects a steering angle of the steering wheel 78 and outputs a steering angle signal indicating a detection result to the vehicle control system 100. The steering torque sensor 80 detects a torque applied to the steering wheel 78 and outputs a steering torque signal indicating a detection result to the vehicle control system 100.

The other driving operation devices 81 are, for example, a joystick, a button, a dial switch, and a graphical user interface (GUI) switch. The other driving operation devices 81 receive an acceleration instruction, a deceleration instruction, a turning instruction and the like, and output the instructions to the vehicle control system 100.

The HMI 70 includes, for example, a display 82, a speaker 83, a touch operation detection device 84, a content reproduction device 85, various operation switches 86, a seat 88, a seat driving device 89, a window glass 90, a window driving device 91, and an in-vehicle cabin camera 95 as the configuration of the non-driving operation system.

The display 82 is, for example, a liquid crystal display (LCD) or an organic electroluminescence (EL) display attached to each unit of an instrument panel, or an arbitrary place facing a passenger seat or a rear seat. Further, the display 82 may be a head up display (HUD) that projects an image to a front windshield or another window. The speaker 83 outputs sound. When the display 82 is a touch panel, the touch operation detection device 84 detects a contact position (a touch position) on a display screen of the display 82 and outputs the contact position to the vehicle control system 100. When the display 82 is not a touch panel, the touch operation detection device 84 may be omitted.

Examples of the content reproduction device 85 include a digital versatile disc (DVD) reproduction device, a compact disc (CD) reproduction device, a television receiver, and various guidance image generation devices. Some or all of the display 82, the speaker 83, the touch operation detection device 84, and the content reproduction device 85 may be configured in common with the navigation device 50.

The various operation switches 86 are disposed at arbitrary places inside a vehicle cabin. The various operation switches 86 include an automated driving changeover switch 87a for instructing starting (or future starting) and stopping of automated driving and a steering switch 87b for switching a display aspect described below. The automated driving changeover switch 87 and the steering switch 87b may be any one of a graphical user interface (GUI) switch and a mechanical switch. Further, the various operation switches 86 may include a switch for driving the seat driving device 89 or the window driving device 91. When the various operation switches 86 receive an operation from the vehicle occupant, the various operation switches 86 output operation signals to the vehicle control system 100.

The seat 88 is a seat on which the vehicle occupant is seated. The seat driving device 89 freely drives a reclining angle, a position in a forward and backward direction, a yaw angle, or the like of the seat 88. The window glass 90 is provided, for example, in each door. The window driving device 91 drives the window glass 90 to open and close the window glass 90.

The in-vehicle cabin camera 95 is a digital camera using an a solid-state imaging element such as a CCD or a CMOS. The in-vehicle cabin camera 95 is attached at a position at which at least a head of the vehicle occupant who performs a driving operation can be imaged, such as a rearview mirror, a steering boss portion, or the instrument panel. The camera 40, for example, periodically repeatedly images the vehicle occupant.

The driving force output device 200, the steering device 210, and the brake device 220 will be described before the vehicle control system 100 is described.

The travel driving force output device 200 outputs a travel driving force (torque) for causing the vehicle to travel to a driving wheel. The travel driving force output device 200, for example, includes an engine, a transmission, and an engine electronic control unit (ECU) that controls the engine in a case in which the subject vehicle M is a car using an internal combustion engine as a power source, includes a traveling motor and a motor ECU that controls the traveling motor in a case in which the subject vehicle M is an electric car using an electric motor as a power source, and includes an engine, a transmission, an engine ECU, a traveling motor, and a motor ECU in a case in which the subject vehicle M is a hybrid vehicle. In a case in which the travel driving force output device 200 includes only an engine, the engine ECU adjusts a throttle opening degree of the engine, a gear shift stage, and the like according to information input from a travel control unit 160 to be described below. Further, when the travel driving force output device 200 includes only a traveling motor, the motor ECU adjusts a duty ratio of a PWM signal to be given to the traveling motor according to the information input from the travel control unit 160. When the travel driving force output device 200 includes an engine and a traveling motor, the engine ECU and the motor ECU cooperate with each other to control the travel driving force according to the information input from the travel control unit 160.

The steering device 210 includes, for example, a steering ECU and an electric motor. The electric motor, for example, changes a direction of the steerable wheels by applying a force to a rack and pinion mechanism. The steering ECU drives the electric motor according to information input from the vehicle control system 100 or input information on the steering angle or the steering torque, to change directions of the steerable wheels.

The brake device 220 is, for example, an electric servo brake device including a brake caliper, a cylinder that transfers hydraulic pressure to the brake caliper, an electric motor that generates the hydraulic pressure in the cylinder, and a brake control unit. The brake control unit of the electric servo brake device controls the electric motor according to the information input from the travel control unit 160 so that a brake torque according to the braking operation is output to each wheel. The electric servo brake device may include, as a backup, a mechanism for transferring the hydraulic pressure generated by the operation of the brake pedal to the cylinder via a master cylinder. It should be noted that the brake device 220 is not limited to the electric servo brake device described above and may be an electronically controlled hydraulic brake device. The electronically controlled hydraulic brake device controls an actuator according to the information input from the travel control unit 160 and transfers the hydraulic pressure of the master cylinder to the cylinder. Further, the brake device 220 may include a regenerative brake using a traveling motor that may be included in the travel driving force output device 200.

### [Vehicle Control System]

Hereinafter, the vehicle control system 100 will be described. The vehicle control system 100 is realized by, for example, one or more processors or hardware having equivalent functions. The vehicle control system 100 may have a configuration in which, for example, a processor such as a central processing unit (CPU), a storage device, an electronic control unit (ECU) having a communication interface connected by an internal bus, and a micro-processing unit (MPU) are combined.

Referring back to FIG. 2, the vehicle control system 100 includes, for example, the target lane determination unit 110, an automated driving control unit 120, a travel control unit 160, and a storage 180. The automated driving control unit 120 includes, for example, an automated driving mode control unit 130, a subject-vehicle position recognition unit 140, an outside world recognition unit 142, an action plan generation unit 144, a trajectory generation unit 146, and a switching control unit 150. The trajectory generation unit 146 and the travel control unit 160 are examples of a “control unit”.

Some or all of each of the target lane determination unit 110, each unit of the automated driving control unit 120, and the travel control unit 160 are realized by the processor executing a program (software). Further, some or all of the units may be realized by hardware such as a large scale integration (LSI) or an application specific integrated circuit (ASIC) or may be realized in a combination of software and hardware.

Information such as high-precision map information 182, target lane information 184, and action plan information 186, for example, is stored in the storage 180. The storage 180 is realized by a read only memory (ROM), a random access memory (RAM), a hard disk drive (HDD), a flash memory, or the like. The program to be executed by the processor may be stored in the storage 180 in advance or may be downloaded from an external device via an in-vehicle Internet facility or the like. Further, the program may be installed in the storage 180 by a portable storage medium having the program stored therein being mounted on a driving device (not illustrated). Further, the vehicle control system 100 may be distributed by a plurality of computer devices.

The target lane determination unit 110 is realized by, for example, an MPU. The target lane determination unit 110 divides the route provided from the navigation device 50 into a plurality of blocks (for example, divides route every 100 [m] in a vehicle traveling direction), and determines the target lane for each block by referring to the high-precision map information 182. The target lane determination unit 110, for example, determines the lane from the left in which the subject vehicle is traveling. The target lane determination unit 110 determines, for example, the target lane so that the subject vehicle M can travel on a reasonable traveling route for traveling to a branch destination when a branch place or a merging place exists in the route. The target lane determined by the target lane determination unit 110 is stored in the storage 180 as the target lane information 184.

The high-precision map information 182 is map information with higher precision than that of the navigation map included in the navigation device 50. The high-precision map information 182 is, for example, information on a center of a lane or information on boundaries of a lane. The high-precision map information 182 may include road information, traffic regulations information, address information (address and postal code), facilities information, telephone number information, and the like. The road information includes information indicating types of road such as expressways, toll roads, national highways, and prefectural roads, or information such as the number of lanes on a road, a width of respective lanes, a gradient of a road, a position of a road (three-dimensional coordinates including a longitude, a latitude, and a height), a curvature of a curve of a lane, a position of a merging or branching point of a lane, and a sign provided on a road. The traffic regulations information includes information such as lane closures due to roadwork, traffic accidents, traffic jams, or the like.

The automated driving mode control unit 130 determines an automated driving mode to be executed by the automated driving control unit 120. The automated driving mode in the first embodiment includes the following modes. It should be noted that the following is merely an example, and the number of automated driving modes may be arbitrarily determined.

### [First Mode]

A first mode is a mode in which a degree of automated driving is highest. When the first mode is performed, all vehicle controls such as complicated merging control are automatically performed, and therefore, the vehicle occupant does not have to monitor surroundings or a state of the subject vehicle M.

### [Second Mode]

A second mode is a mode in which the degree of automated driving is high next to the first mode. When the second mode is performed, x all the vehicle controls is automatically performed in principle, but the driving operation of the subject vehicle M is entrusted to the vehicle occupant according to scenes. Therefore, it is necessary for the vehicle occupant to monitor the surroundings or state of the subject vehicle M.

### [Third Mode]

A third mode is a mode in which the degree of automated driving is high next to the second mode. When the third mode is performed, the vehicle occupant needs to perform a confirmation operation according to scenes with respect to the HMI 70. In the third mode, for example, the vehicle occupant is notified of a timing of a lane change, and when the vehicle occupant performs an operation for instructing to change the lane with respect to the HMI 70, automated lane change is performed. Therefore, it is necessary for the vehicle occupant to monitor the surroundings or state of the subject vehicle M.

The automated driving mode control unit 130 determines the automated driving mode on the basis of an operation of the vehicle occupant with respect to the HMI 70, an event determined by the action plan generation unit 144, a traveling aspect determined by the trajectory generation unit 146, and the like. Further, the HMI control unit 170 is notified of the automated driving mode. Further, in the automated driving mode, a limit may be set according to the performance or the like of the detection device DD of the subject vehicle M. For example, when the performance of the detection device DD is low, the first mode may not be performed. In any of the modes, switching to the manual driving mode (overriding) can be performed according to an operation with respect to a configuration of a driving operation system in the HMI 70.

The subject-vehicle position recognition unit 140 recognizes a lane (traveling lane) in which the subject vehicle M is traveling, and a relative position of the subject vehicle M with respect to the traveling lane, on the basis of the high-precision map information 182 stored in the storage 180, and information input from the finder 20, the radar 30, the camera 40, the navigation device 50, or the vehicle sensor 60.

The subject-vehicle position recognition unit 140 compares, for example, a pattern of a road division line (for example, an arrangement of a solid line and a broken line) recognized from the high-precision map information 182 with a pattern of a road division line around the subject vehicle M recognized from an image captured by the camera 40 to recognize the traveling lane. In this recognition, the position of the subject vehicle M acquired from the navigation device 50 or a processing result by an INS may be added.

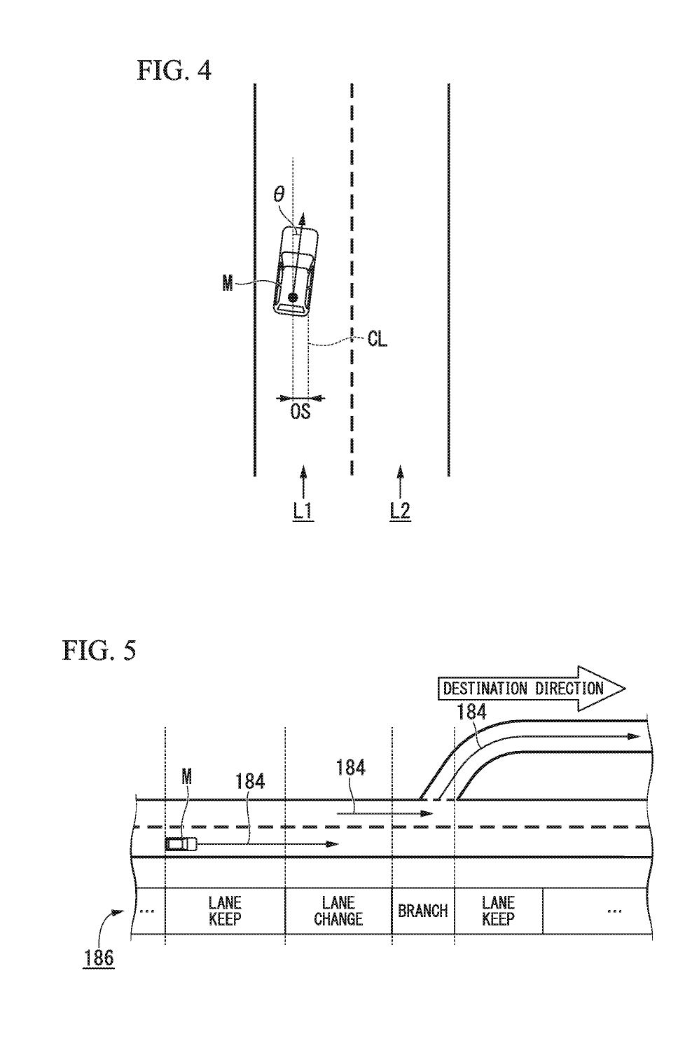

FIG. 4 is a diagram illustrating a state in which the relative position of the subject vehicle M with respect to the travel lane L1 is recognized by the subject-vehicle position recognition unit 140. The subject-vehicle position recognition unit 140, for example, may recognize a deviation OS of a reference point (for example, a centroid) of the subject vehicle M from a travel lane center CL, and an angle θ with respect to a connecting line along the travel lane center CL in the travel direction of the subject vehicle M, as the relative position of the subject vehicle M with respect to a travel lane L1. It should be noted that, instead of this, the subject-vehicle position recognition unit 140 may recognize, for example, the position of the reference point of the subject vehicle M with respect to any one side end portion of the subject lane L1 as the relative position of the subject vehicle M with respect to the travel lane. The relative position of the subject vehicle M recognized by the subject-vehicle position recognition unit 140 is provided to the target lane determination unit 110.

The outside world recognition unit 142 recognizes a state such as a position, a speed, and an acceleration of a nearby vehicle on the basis of information input from the finder 20, the radar 30, the camera 40, and the like. The nearby vehicle is, for example, a vehicle that is traveling nearby the subject vehicle M and is a vehicle that travels in the same direction as that of the subject vehicle M. The position of the nearby vehicle may be represented by a representative point such as a centroid or a corner of another vehicle or may be represented by an area represented by an outline of another vehicle. The “state” of the nearby vehicle may include an acceleration of the nearby vehicle, and an indication of whether or not the nearby vehicle is changing lane (or whether or not the nearby vehicle is about to change lane), which are recognized on the basis of the information of the various devices described above. Further, the outside world recognition unit 142 may also recognize positions of a guardrail, a utility pole, a parked vehicle, a pedestrian, a dropped object, a crossing, a traffic sign, a signboard installed near a construction site or the like, and other objects, in addition to nearby vehicles.

The action plan generation unit 144 sets a starting point of automated driving and/or a destination for automated driving. The starting point of automated driving may be a current position of the subject vehicle M or may be a point at which an operation for instructing automated driving is performed. The action plan generation unit 144 generates the action plan in a section between the starting point and the destination of automated driving. It should be noted that the present invention is not limited thereto, and the action plan generation unit 144 may generate the action plan for any section.

The action plan includes, for example, a plurality of events that are executed sequentially. Examples of the events include a deceleration event for decelerating the subject vehicle M, an acceleration event for accelerating the subject vehicle M, a lane keeping event for causing the subject vehicle M to travel so that the subject vehicle M does not deviate from a travel lane, a lane change event for changing travel lane, an overtaking event for causing the subject vehicle M to overtake a preceding vehicle, a branching event for changing a lane to a desired lane at a branch point or causing the subject vehicle M to travel so that the subject vehicle M does not deviate from a current travel lane, a merging event for accelerating and decelerating the subject vehicle M at a merging lane for merging into a main lane and changing travel lane, and a handover event in which the driving mode is shifted from the manual driving mode to the automated driving mode at a start point of automated driving or the driving mode is shifted from the automated driving mode to the manual driving mode at a scheduled end point of automated driving. The action plan generation unit 144 sets a lane change event, a branching event, or a merging event at a place at which the target lane determined by the target lane determination unit 110 is switched. Information indicating the action plan generated by the action plan generation unit 144 is stored in the storage 180 as the action plan information 186.

FIG. 5 is a diagram illustrating an example of an action plan generated for a certain section. As illustrated in FIG. 5, the action plan generation unit 144 generates an action plan necessary for the subject vehicle M to travel on the target lane indicated by the target lane information 184. It should be noted that the action plan generation unit 144 may dynamically change the action plan irrespective of the target lane information 184 according to a situation change of the subject vehicle M. For example, when a speed of the nearby vehicle recognized by the outside world recognition unit 142 exceeds a threshold value during vehicle traveling or a moving direction of the nearby vehicle traveling in the lane adjacent to the subject lane is directed to a direction of the subject lane, the action plan generation unit 144 may change an event set in a driving section in which the subject vehicle M is scheduled to travel. For example, in a case in which an event is set so that a lane change event is executed after a lane keeping event, when it has been found from a result of the recognition of the outside world recognition unit 142 that a vehicle travels at a speed equal to or higher than a threshold value from behind in a lane that is a lane change destination during the lane keeping event, the action plan generation unit 144 may change an event subsequent to the lane keeping event from a lane change event to a deceleration event, a lane keeping event, or the like. As a result, even when a change occurs in a state of the outside world, the vehicle control system 100 can cause the subject vehicle M to safely automatically travel.

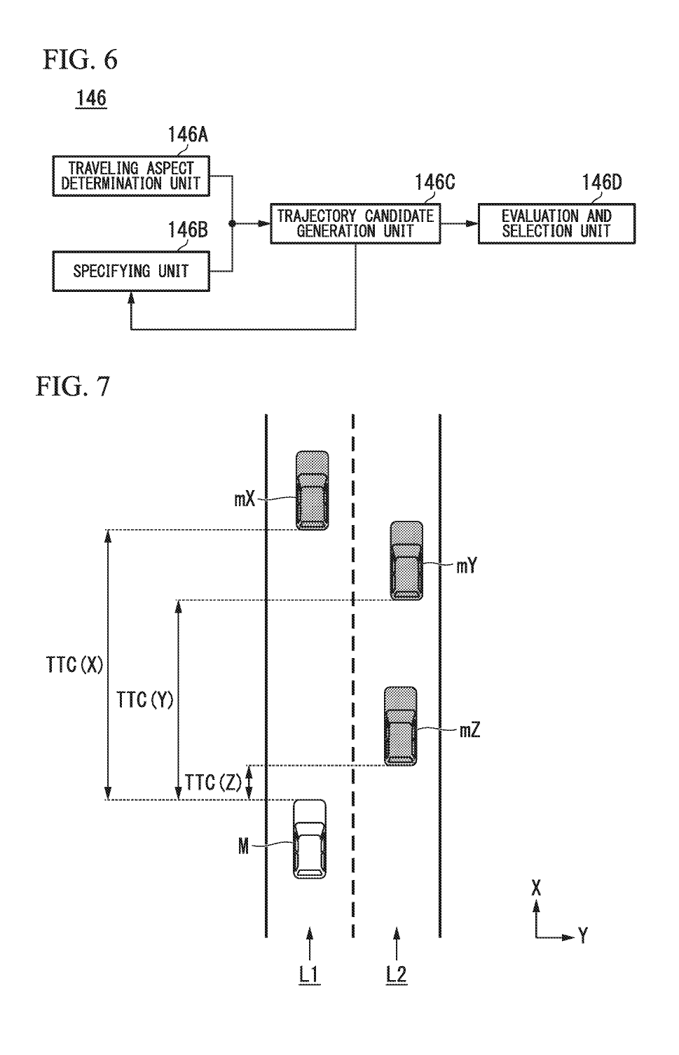

FIG. 6 is a diagram illustrating an example of a configuration of the trajectory generation unit 146. The trajectory generation unit 146 includes, for example, a traveling aspect determination unit 146A, a specifying unit 146B, a trajectory candidate generation unit 146C, and an evaluation and selection unit 146D.

When a lane keeping event is performed, the traveling aspect determination unit 146A determines a traveling aspect of any one of constant speed traveling, following traveling, low speed following traveling, decelerating traveling, curved traveling, obstacle avoidance traveling, and the like. For example, when there are no other vehicles in front of the subject vehicle M, the traveling aspect determination unit 146A determines the traveling aspect to be constant speed traveling. Further, when the vehicle follows the preceding vehicle, the traveling aspect determination unit 146A determines the traveling aspect to be following traveling. Further, the traveling aspect determination unit 146A determines the traveling aspect to be the low speed follow traveling in a congested situation or the like. Further, when the outside world recognition unit 142 recognizes deceleration of the preceding vehicle or when an event such as stopping or parking is performed, the traveling aspect determination unit 146A determines the traveling aspect to be decelerating traveling. Further, when the outside world recognition unit 142 recognizes that the subject vehicle M has arrived at a curved road, the traveling aspect determination unit 146A determines the traveling aspect to be curved traveling. Further, when an obstacle is recognized in front of the subject vehicle M by the outside world recognition unit 142, the traveling aspect determination unit 146A determines the traveling aspect to be the obstacle avoidance traveling.

The specifying unit 146B specifies a nearby vehicle (hereinafter referred to as a monitored vehicle) that is likely to influence the acceleration/deceleration or the steering of the subject vehicle M among nearby vehicles of which states are recognized by the outside world recognition unit 142. The monitored vehicle is, for example, the nearby vehicle of which a relative position with respect to the subject vehicle M approaches the subject vehicle M over time.

For example, the specifying unit 146B determines whether or not the nearby vehicle is the monitored vehicle in consideration of a time to collision (TTC) between the subject vehicle M and the nearby vehicle. FIG. 7 is a diagram illustrating the time to collision TTC between the subject vehicle M and the nearby vehicle. In the illustrated example, three vehicles mX, mY, and mZ are recognized as the nearby vehicles by the outside world recognition unit 142. In this case, the specifying unit 146B determines whether or not each of a time to collision TTC(X) between the subject vehicle M and the vehicle mX, a time to collision TTC(Y) between the subject vehicle M and the vehicle mY, and a time to collision TTC(Z) between the subject vehicle M and the vehicle mZ exceeds a threshold value for maintaining a sufficient inter-vehicle distance. The time to collision TTC(X) is a time that is derived by dividing the distance from the subject vehicle M to the vehicle mX by a relative speed of the subject vehicle M and the vehicle mX. The time to collision TTC(Y) is a time that is derived by dividing the distance from the subject vehicle M to the vehicle mY by a relative speed of the subject vehicle M and the vehicle mY. The time to collision TTC(Z) is a time that is derived by dividing the distance from the subject vehicle M to the vehicle mZ by a relative speed of the subject vehicle M and the vehicle mZ. When there is the nearby vehicle of which the time to collision TTC exceeds the threshold value, the specifying unit 146B determines that the vehicle is the monitored vehicle.

Further, the specifying unit 146B treats the nearby vehicle located near the trajectory generated by the trajectory candidate generation unit 146C to be described below and selected by the evaluation and selection unit 146D among the nearby vehicles of which the states are recognized by the outside world recognition unit 142, as the monitored vehicle. “Near the trajectory” means that a part of a body of the nearby vehicle overlaps with the trajectory or that the distance between the trajectory and the nearby vehicle is within a predetermined range (for example, about several meters).

Further, in another viewpoint, the nearby vehicle located near the trajectory is a nearby vehicle that is considered when the trajectory candidate generation unit 146C generates the trajectory. Therefore, the specifying unit 146B may treat the nearby vehicle considered by the trajectory candidate generation unit 146C as the monitored vehicle.

Further, the specifying unit 146B may treat another object (for example, an object that can be an obstacle in front of the subject vehicle M) recognized by the outside world recognition unit 142 as an object corresponding to the monitored vehicle.

Further, when the monitored vehicle is specified, the specifying unit 146B may further select the monitored vehicle on the basis of the priority according to the above conditions. For example, a priority to be set for a nearby vehicle present on a route (target lane) on which the subject vehicle M travels, or a priority to be set for a nearby vehicle directed to the subject vehicle M is set to be higher than a priority to be set for vehicles other than the nearby vehicles. That is, the nearby vehicle present on the route (the target lane) on which the subject vehicle M travels or the nearby vehicle directed to the subject vehicle M is easily selected as the monitored vehicle as compared with the vehicles other than the nearby vehicles.

Further, the specifying unit 146B may select, for example, the nearby vehicle further satisfying a plurality of conditions such as the time to collision TTC exceeding the threshold value and nearby vehicle being located near the trajectory, as a monitored vehicle. In this case, the specifying unit 146B, for example, ranks nearby vehicles in an order of the number of satisfied conditions and treats a predetermined number (for example, top three) of nearby vehicles from the top of the ranking as a monitored vehicle. As a result, the number of vehicles displayed on the display 82 can be reduced under control of the HMI control unit 170 to be described below, and the vehicle occupant can be informed of a surrounding situation of the subject vehicle M in a brief manner.

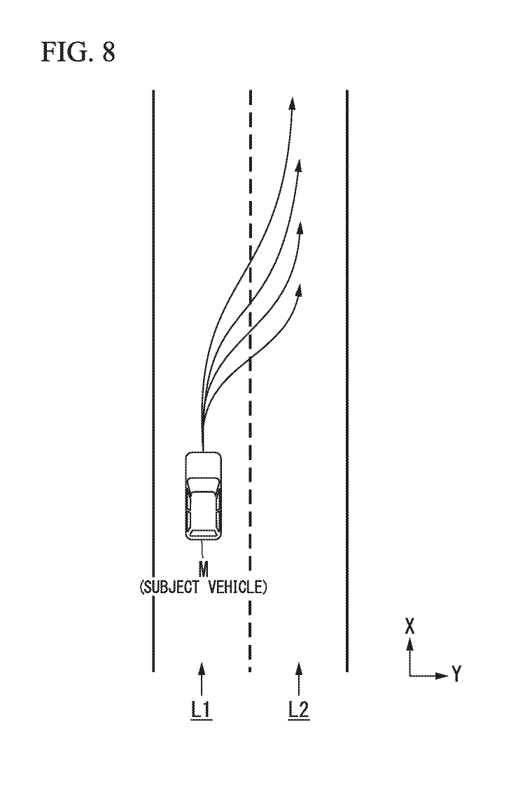

The trajectory candidate generation unit 146C generates candidates for the trajectory on the basis of the traveling aspect determined by the traveling aspect determination unit 146A. FIG. 8 is a diagram illustrating an example of candidates for the trajectory generated by the trajectory candidate generation unit 146C. FIG. 8 illustrates candidates for the trajectory generated when the subject vehicle M changes the lane from the lane L1 to the lane L2.

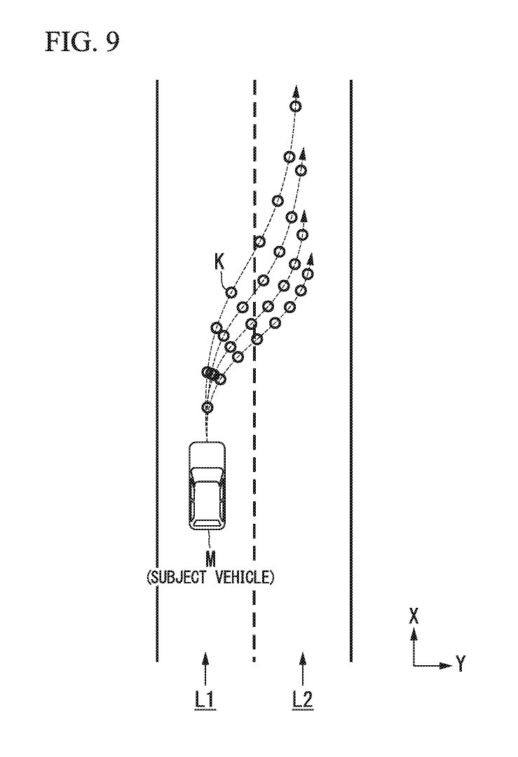

The trajectory candidate generation unit 146C determines the trajectory as illustrated in FIG. 8, for example, to be a collection of the target positions (the trajectory points K) that the reference position (for example, a centroid or a rear wheel shaft center) of the subject vehicle M should reach at every predetermined time in the future. FIG. 9 is a diagram in which the candidate for the trajectory generated by the trajectory candidate generation unit 146C is represented by the trajectory points K. When an interval between the trajectory points K is wider, the speed of the subject vehicle M becomes higher, and when the interval between the trajectory points K is narrower, the speed of the subject vehicle M becomes lower. Therefore, the trajectory candidate generation unit 146C gradually widens the interval between the trajectory points K when acceleration is desired, and gradually narrows the interval between the trajectory points when deceleration is desired.

Thus, since the trajectory point K includes a speed component, the trajectory candidate generation unit 146C needs to give a target speed to each trajectory point K. The target speed is determined according to the traveling aspect determined by the traveling aspect determination unit 146A.

A scheme of determining the target speed when lane change (including branching) is performed will be described herein. The trajectory candidate generation unit 146C first sets a lane changing target position (or a merging target position). The lane changing target position is set as a relative position with respect to the nearby vehicle and is used for a determination as to “whether the lane change is performed between the subject vehicle and a certain nearby vehicle”. The trajectory candidate generation unit 146C determines the target speed when the lane change is performed while focusing on three nearby vehicles with reference to the lane changing target position.

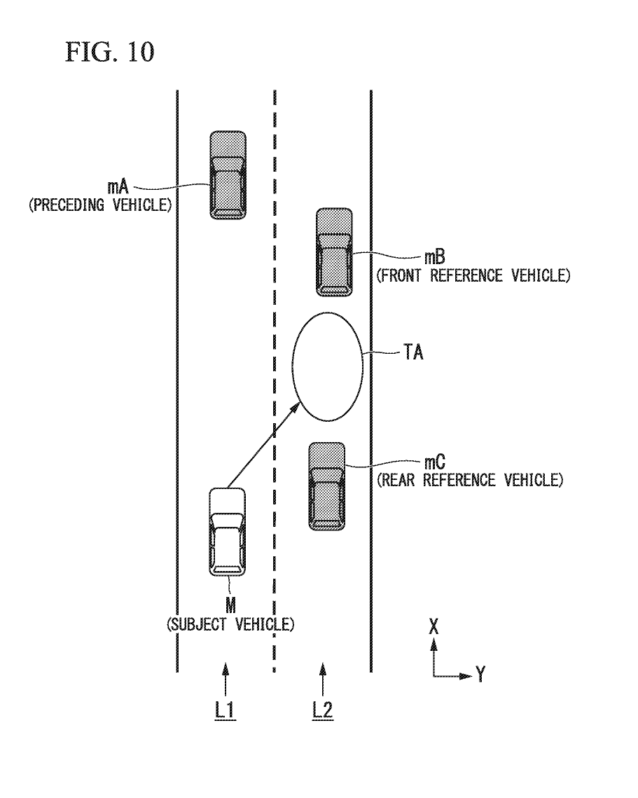

FIG. 10 is a diagram illustrating the lane changing target position TA. In FIG. 10, L1 indicates the subject lane, and L2 indicates an adjacent lane. Here, a nearby vehicle traveling in front of the subject vehicle M on the same lane as that of the subject vehicle M is referred to as a preceding vehicle mA, a nearby vehicle traveling immediately before the lane changing target position TA is referred to as a front reference vehicle mB, and a nearby vehicle traveling immediately after the lane changing target position TA is referred to as a rear reference vehicle mC. The subject vehicle M needs to perform acceleration or deceleration in order to move to the side of the lane changing target position TA, but should avoid catching up with the preceding vehicle mA in this case. Therefore, the trajectory candidate generation unit 146C predicts a future state of the three nearby vehicles and determines a target speed so that the subject vehicle M does not interfere with each nearby vehicle.

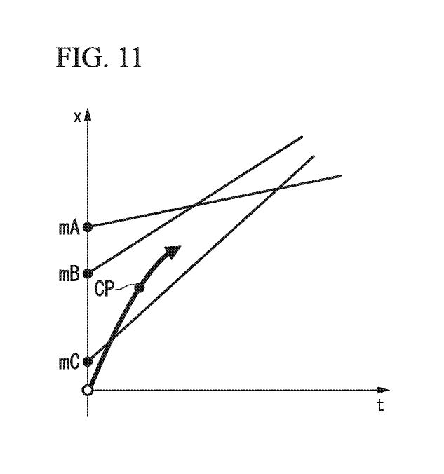

FIG. 11 is a diagram illustrating a speed generation model when speeds of three nearby vehicles are assumed to be constant. In FIG. 11, straight lines extending from mA, mB, and mC indicate displacements in the traveling direction when each nearby vehicle is assumed to travel at a constant speed. The subject vehicle M should be between the front reference vehicle mB and the rear reference vehicle mC at a point CP at which the lane change is completed and should be behind the preceding vehicle mA before that. Under such restrictions, the trajectory candidate generation unit 146C derives a plurality of time-series patterns of the target speed until the lane change is completed. The trajectory candidate generation unit 146B derives a plurality of trajectory candidates as illustrated in FIG. 9 by applying the time-series patterns of the target speed to a model such as a spline curve. It should be noted that a motion pattern of the three nearby vehicles is not limited to the constant speed as illustrated in FIG. 11, but the prediction may be performed on the premise of constant acceleration and constant jerk.

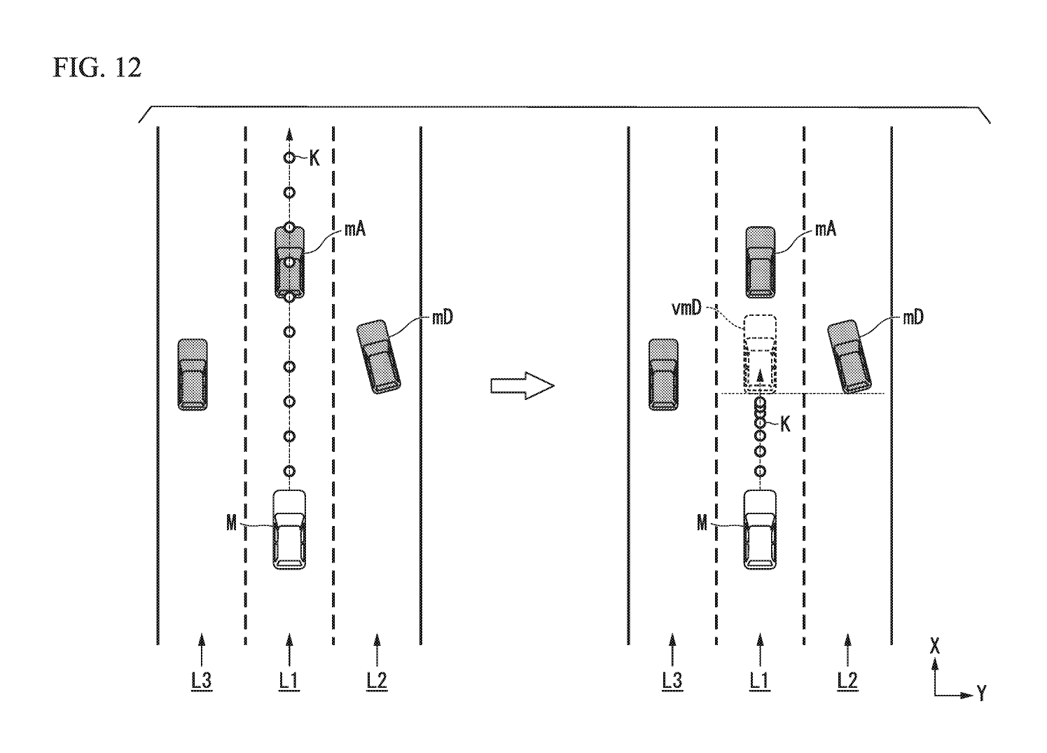

Further, the trajectory candidate generation unit 146C may correct the generated trajectory on the basis of the state of the monitored vehicle specified by the specifying unit 146B. FIG. 12 is a diagram illustrating an example of a scene in which the trajectory is corrected. For example, in a case in which the trajectory candidate generation unit 146C has generated a trajectory following the front vehicle mA and when the vehicle mD traveling in the adjacent lane L2 tries to change the lane to the subject lane L1, the trajectory candidate generation unit 146C compares a position of the vehicle mD with a position of the front vehicle mA that is a follow-up target in a vehicle traveling direction. An operation in which the other vehicle tries to change the lane to the subject lane is judged, for example, on the basis of blinking of a blinker, a direction of a vehicle body, a moving direction of the other vehicle (a vector of an acceleration or speed), and the like. When the vehicle mD is closer to the subject vehicle M, the trajectory candidate generation unit 146C sets a virtual vehicle vmD virtually simulating the vehicle mD to be on the side of the vehicle mD on the subject lane L1. This virtual vehicle vmD is set, for example, as a vehicle having the same speed as the speed of the vehicle mD.

The trajectory candidate generation unit 146C sets the follow-up target to the virtual vehicle vmD and corrects the trajectory with a trajectory in which an interval between the trajectory points K is decreased so that the inter-vehicle distance to the virtual vehicle vmD is sufficiently great, and the subject vehicle M is decelerated. After the sufficient inter-vehicle distance is secured, the trajectory candidate generation unit 146C may correct the trajectory with a trajectory in which the speed is the same as that of the virtual vehicle vmD, for example, so that the subject vehicle m follows the virtual vehicle vmD.

The evaluation and selection unit 146D performs evaluation on the trajectory candidates generated by the trajectory candidate generation unit 146C, for example, from two viewpoints including planning and safety, and selects a trajectory to be output to the travel control unit 160. From the viewpoint of the planning, for example, when follow-up with respect to an already generated plan (for example, the action plan) is high and a total length of the trajectory is short, the trajectory obtains high evaluation. For example, a trajectory in which the lane is changed to the left direction and then returning is required when the lane is desired to be changed to the right obtains a low evaluation. From the viewpoint of the safety, for example, as a distance between the subject vehicle M and an object (a nearby vehicle or the like) is longer at each trajectory point and the amount of change in acceleration and deceleration or steering angle is smaller, high evaluation is obtained.

The switching control unit 150 switches the driving mode between the automated driving mode and the manual driving mode on the basis of the signal input from the automated driving changeover switch 87a. Further, the switching control unit 150 switches driving mode from the automated driving mode to the manual driving mode on the basis of an operation for instructing acceleration, deceleration, or steering with respect to a configuration of the driving operation system in the HMI 70. For example, the switching control unit 150 switches the driving mode from the automated driving mode to the manual driving mode when a state in which the amount of operation indicated by the signal input from the configuration of the driving operation system in the HMI 70 exceeds a threshold value continues for a reference time or more (overriding). Further, the switching control unit 150 may cause the driving mode to return to the automated driving mode when no operation with respect to the configuration of the driving operation system in the HMI 70 is detected for a predetermined time after switching to the manual driving mode by overriding.

The travel control unit 160 controls the travel driving force output device 200, the steering device 210, and the brake device 220 so that the subject vehicle M passes through the trajectory generated by the trajectory generation unit 146 at the scheduled time.

The HMI control unit 170 controls the HMI 70 when automated driving mode information is notified of by the automated driving control unit 120. For example, the HMI control unit 170 causes the display 82 to display at least information on the presence of the monitored vehicle as an image in a state in which a relative position between the monitored vehicle specified by the specifying unit 146B and the subject vehicle M is maintained. The information on the presence of the monitored vehicle is, for example, a relative position of the monitored vehicle with respect to the subject vehicle M, the presence or absence, a size, or a shape of the monitored vehicle, and the like. When the HMI control unit 170 causes the display 82 to display the information on the presence of the monitored vehicle as the image, the HMI control unit 170 changes the display aspect on the basis of a distance D from the subject vehicle M to the monitored vehicle in the traveling direction of the vehicle. The HMI control unit 170 is an example of an “output control unit”.

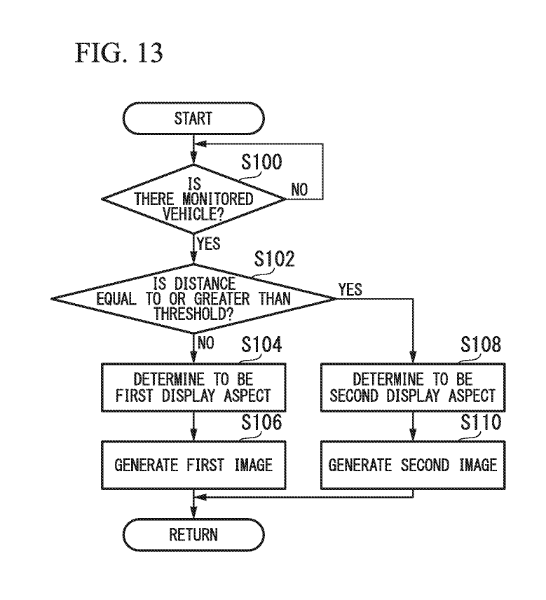

Hereinafter, a process of the HMI control unit 170 will be described with reference to a flowchart. FIG. 13 is a flowchart showing an example of a flow of a process of the HMI control unit 170 in the embodiment. The process of this flowchart is repeated, for example, at a predetermined cycle of several seconds to about tens of seconds.

First, the HMI control unit 170 stands by until the monitored vehicle is specified from among the nearby vehicles by the specifying unit 146B (step S100) and determines whether or not a distance D to the monitored vehicle is equal to or more than a threshold value D_{Th} when the monitored vehicle is specified (step S102).

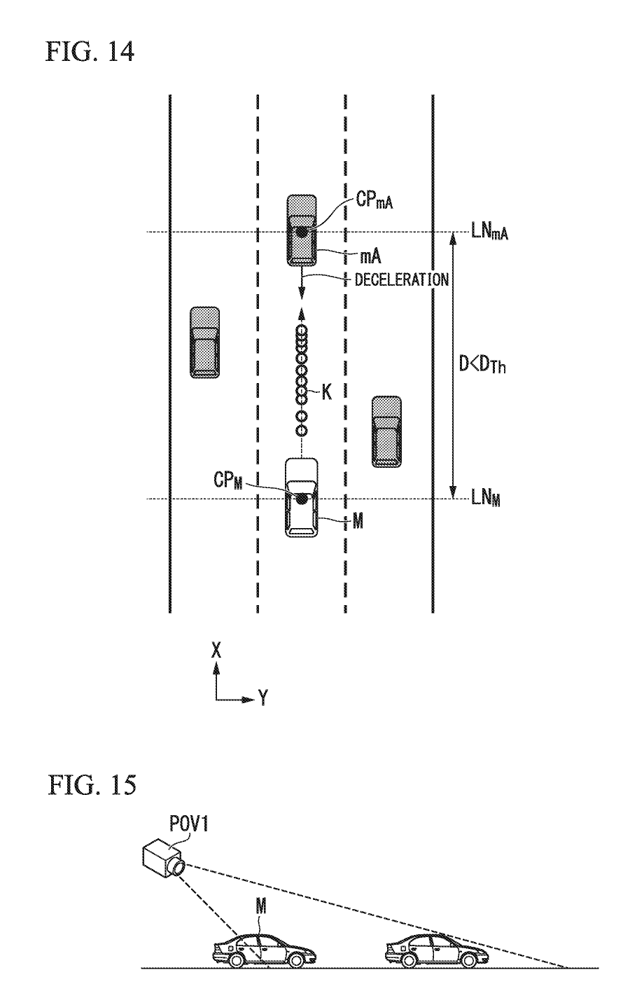

Hereinafter, a scheme of determining the threshold value D_{Th} will be described with reference to the drawings. FIG. 14 is a diagram illustrating an example of a scene in which the front vehicle mA decelerates. In such a scene, the specifying unit 146B derives the time to collision TTC with the front vehicle mA, and specifies the front vehicle mA as the monitored vehicle at a point in time when the time to collision TTC becomes equal to or less than the threshold value. In this case, the trajectory candidate generation unit 146C generates a trajectory for decelerating the subject vehicle M. When the monitored vehicle is specified by the specifying unit 146B, the HMI control unit 170 derives the distance D to the monitored vehicle. For example, the HMI control unit 170 derives a distance D between an extension line LN_{M} extending in a lane width direction from a reference position of the subject vehicle M and an extension line LN_{MA} extending in the lane width direction from a reference position (for example, a centroid or a rear wheel shaft center) of the front vehicle mA treated as the monitored vehicle, and compares this distance D with the threshold value D_{Th}. As in the illustrated example, when the distance D is smaller than the threshold value D_{Th}, the HMI control unit 170 determines a display aspect when the HMI control unit 170 causes the display 82 to display the image, to be the first display aspect (step S104).

FIG. 15 is a diagram illustrating the first display aspect. The first display aspect is, for example, an aspect in which an image when a nearby vehicle is caught from a viewpoint POV1 in FIG. 15 is displayed. For example, the HMI control unit 170 expresses the monitored vehicle and the subject vehicle M as a three-dimensional shape model on a road plane while maintaining the relative position between the monitored vehicle and the subject vehicle M, and generates an image (hereinafter referred to as a first image) which is obtained when an area including at least the monitored vehicles is imaged from the viewpoint POV1 (step S106). The first image may further include a part or all of the subject vehicle M.

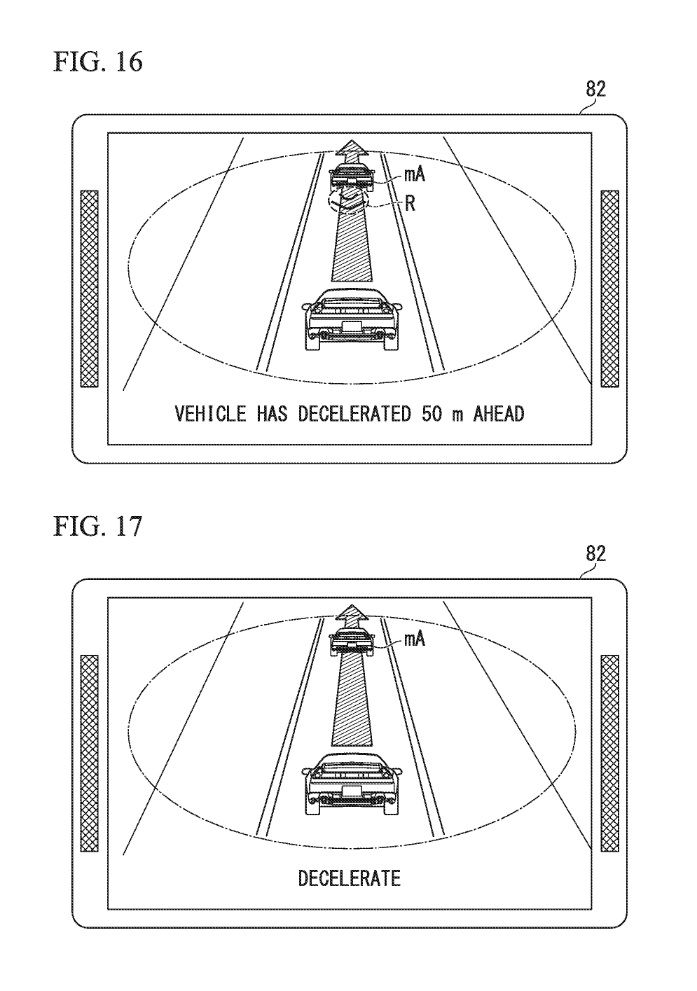

FIG. 16 is a diagram illustrating an example of the first image displayed on the display 82. The example of FIG. 16 is the first image generated in the scene of FIG. 14. For example, the HMI control unit 170 draws only a decelerated front vehicle mA (only the monitored vehicle) in the first image and expresses a behavior of the front vehicle mA like an area R in FIG. 16. Further, the HMI control unit 170 may express information including a derived distance D as letters or the like, as illustrated in FIG. 16.

FIG. 17 is a diagram illustrating an example of a first image continuously displayed after the first image illustrated in FIG. 16. In the first image illustrated in FIG. 17, as the monitored vehicle is specified, a behavior of the subject vehicle M is drawn. In the case of the illustrated example, the trajectory generation unit 146 generates a trajectory for decelerating the subject vehicle M as the front vehicle mA, which is the monitored vehicle, decelerates. Further, the HMI control unit 170 may express the fact that the subject vehicle M decelerates according to the trajectory generated by the trajectory generation unit 146 with letters or the like, as illustrated in FIG. 17.

Thus, since the content of control of the automated driving control unit 120 is displayed as the image (or a moving image) on the display 82, the vehicle occupant can recognize a scheduled behavior of the subject vehicle M.

On the other hand, when the distance D is greater than the threshold value D_{Th} in the processing of S102 in FIG. 13, the HMI control unit 170 determines a display aspect at the time of causing the image to be displayed on the display 82, to be a second display aspect (step S108).

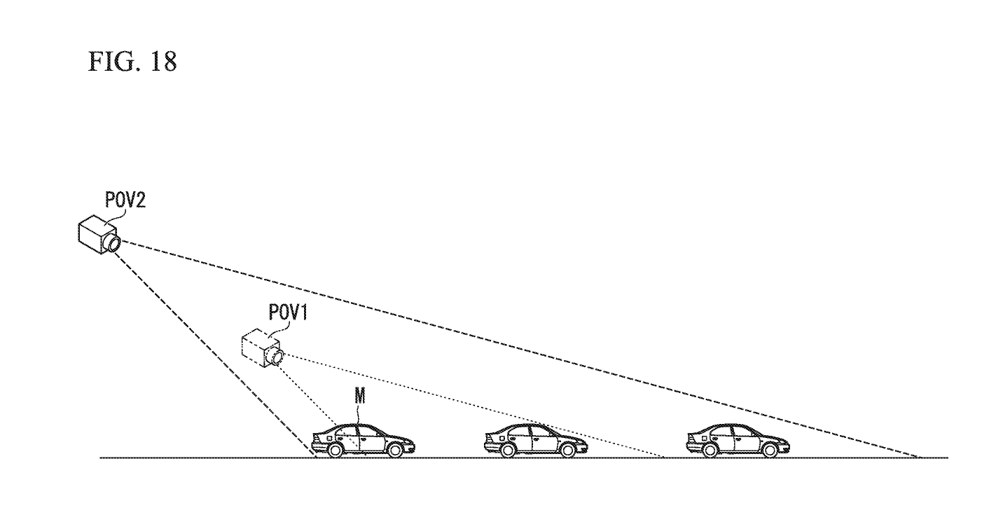

FIG. 18 is a diagram illustrating the second display aspect. The second display aspect is, for example, an aspect in which an image when nearby vehicles are caught from a viewpoint POV2 on the upper side and/or the rear side of the vehicle relative to the position of the above-described viewpoint POV1 is displayed. The viewpoint POV1 is an example of a “first viewpoint”, and the viewpoint POV2 is an example of a “second viewpoint”.

For example, the HMI control unit 170 expresses the monitored vehicle and the subject vehicle M as a three-dimensional shape model on the road plane while maintaining the relative position between the monitored vehicle and the subject vehicle M, and generates an image (hereinafter referred to as a second image) which is obtained when an area including at least the monitored vehicles is imaged from the viewpoint POV2, as in the case of the first image (step S110). The second image may further include a part or all of the subject vehicle M.

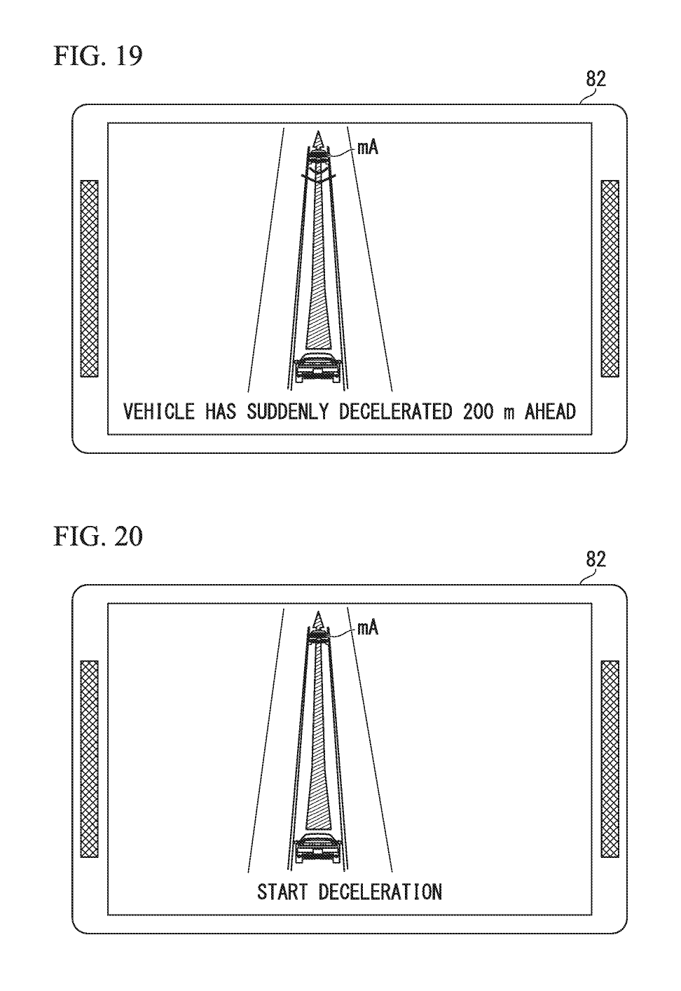

FIG. 19 is a diagram illustrating an example of the second image displayed on the display 82. Further, FIG. 20 is a diagram illustrating an example of a second image that is displayed continuously after the second image illustrated in FIG. 19. For example, the HMI control unit 170 causes the display 82 to display information such as a behavior of the monitored vehicle (the front vehicle mA in this case), the trajectory, or the content of control of the subject vehicle M as the second image, as in the case of the first image.

Further, when the distance D is greater than the threshold value D_{Th}, the HMI control unit 170 may generate a third image obtained by cutting out an area exceeding the threshold value D_{Th}.

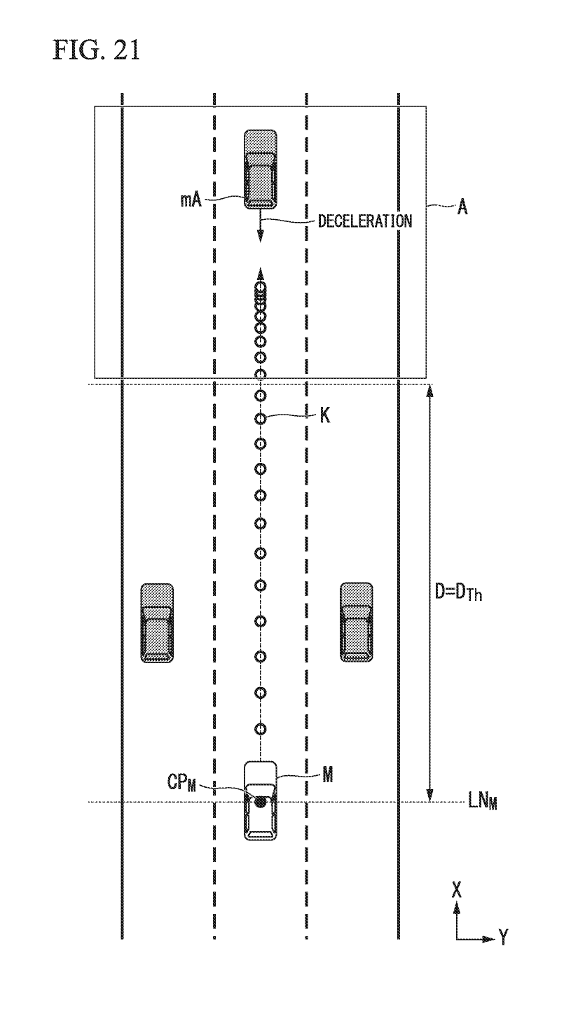

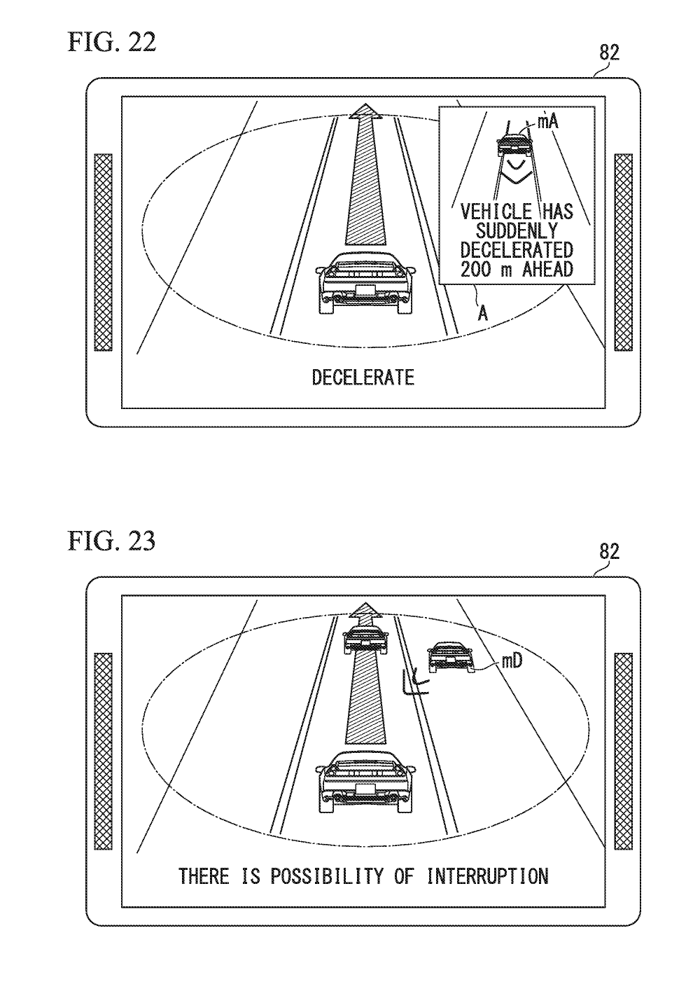

FIG. 21 is a diagram illustrating an example of a scene in which the distance D is greater than the threshold value D_{Th}. In the case of such a scene, the HMI control unit 170 generates a third image obtained by cutting out only the area A in which the distance D exceeds the threshold value D_{Th}. FIG. 22 is a diagram illustrating an example of the third image displayed together with the first image. A in FIG. 22 corresponds to the third image obtained by cutting out the area A in FIG. 21.

It should be noted that switching between the first display aspect and the second display aspect determined in the above-described process is performed by the vehicle occupant touching a display screen of the display 82 or operating the steering switch 87b. That is, the HMI control unit 170 switches the image displayed on the display 82 from the first image to the second image (or the third image) or from the second image (or the third image) to the first image on the basis of one or both of a detection signal of the touch operation detection device 84 and an operation signal of the steering switch 87b. The touch operation detection device 84 and the steering switch 87b are examples of an “operation unit”.

Hereinafter, a case in which the monitored vehicles are nearby vehicles crossing the subject lane from an adjacent lane, a case in which the monitored vehicle is an obstacle such as a stopped vehicle, and a case in which the monitored vehicle is a vehicle to be considered at the time of lane change will be described as other examples.

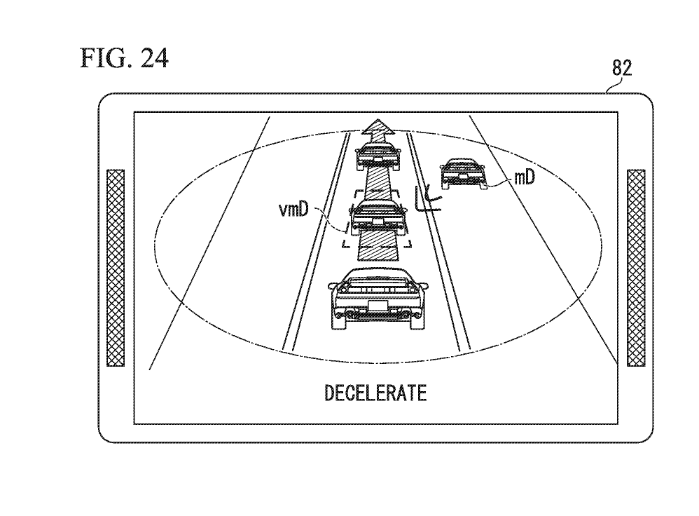

FIGS. 23 and 24 are diagrams illustrating an example of a first image displayed when the monitored vehicle is a nearby vehicle crossing the subject lane from the adjacent lane. In FIGS. 23 and 24, mD indicates a nearby vehicle trying to change the lane from the adjacent lane to the subject lane, as in FIG. 12 described above. For example, the HMI control unit 170 causes the first image in which interruption of the nearby vehicle mD is expressed to be displayed as illustrated in FIG. 23, and then, causes a first image in which a virtual image vmD virtually simulating the nearby vehicle mD is expressed as a three-dimensional shape model on the road plane to be continuously displayed as illustrated in FIG. 24. Accordingly, the vehicle control system 100 can cause the vehicle occupant to recognize a future position of the nearby vehicle.

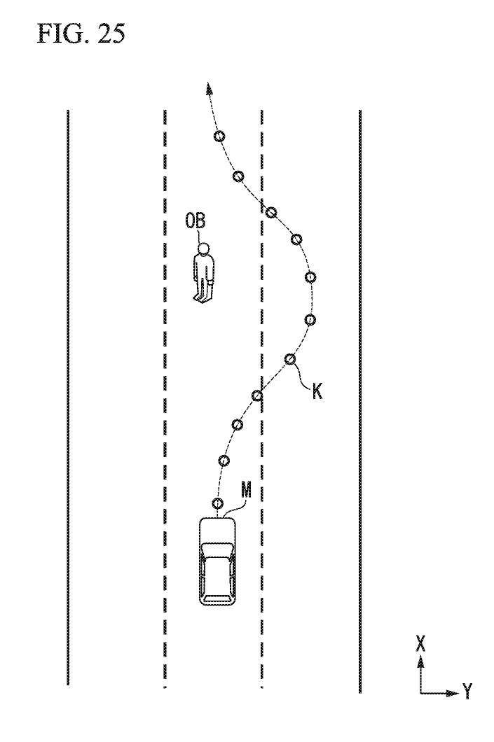

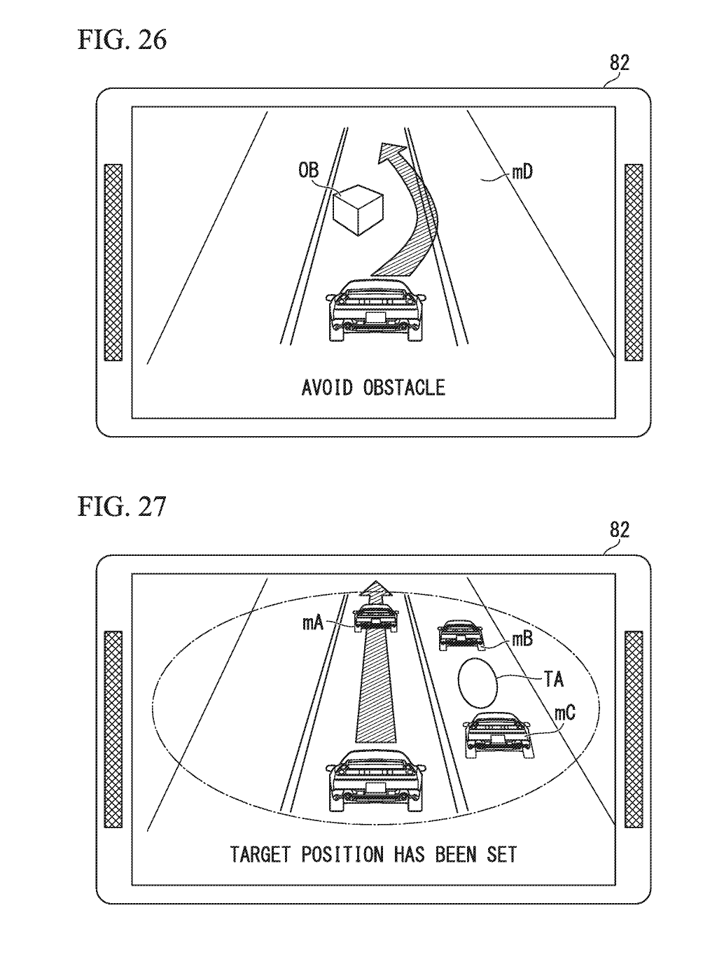

FIG. 25 is a diagram illustrating an example of a trajectory that is generated in a scene in which an obstacle OB is present in front of the subject vehicle M. In the illustrated case, since a traveling aspect is determined to be obstacle avoidance traveling by the traveling aspect determination unit 146A, the trajectory generation unit 146 generates, for example, an avoidance trajectory in which some of the trajectory points K are arranged on the adjacent lane around the obstacle OB. In this case, the HMI control unit 170 expresses the obstacle OB as a three-dimensional shape model on the road plane and draws the avoidance trajectory on the road plane. FIG. 26 is a diagram illustrating an example of an image that is displayed on the display 82 in the scene of FIG. 25.

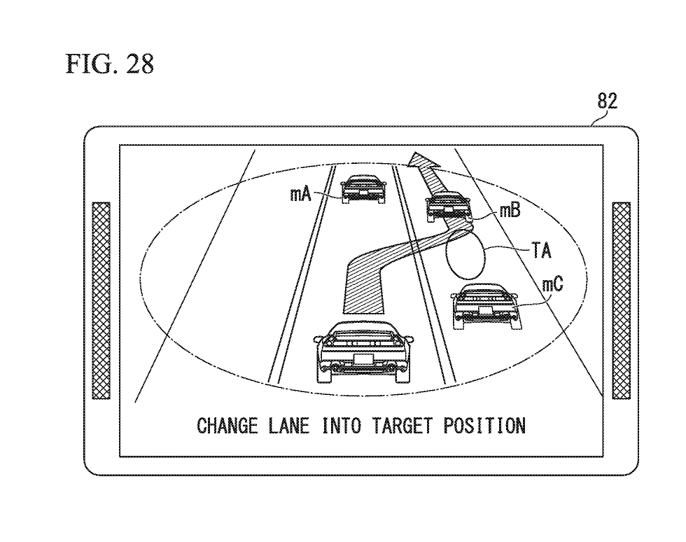

FIGS. 27 and 28 are diagrams illustrating an example of the first image displayed when the monitored vehicle is a vehicle to be considered at the time of lane changing. In FIGS. 27 and 28, mA, mB, and mC indicate a front vehicle, a front reference vehicle, and a rear reference vehicle, similar to FIGS. 10 and 12 described above. It should be noted that when a distance D to any one of the three monitored vehicles exceeds the threshold value D_{Th}, information on the presence of the monitored vehicles may be displayed as a second image or a third image.

In the above scene, the HMI control unit 170 draws the lane change target position TA between the front reference vehicle mB and the rear reference vehicle mC on the road plane and expresses the fact that the lane is to be changed toward the lane change target position TA using letters or the like. Further, the HMI control unit 170 draws the trajectory generated for lane changing. Accordingly, the vehicle occupant compares a state of the front of the subject vehicle M visually recognized by the vehicle occupant with the image displayed on the display 82, thereby recognizing a position to which the subject vehicle M tries to change the lane.

It should be noted that the above-described HMI control unit 170 has been described as informing the occupant of the vehicle of the presence or absence of the monitored vehicle or the relative positional relationship with the subject vehicle M by causing various images to be displayed on the HMI 70, but the present invention is not limited thereto. For example, the HMI control unit 170 may inform the occupant of the vehicle of the presence or absence of the monitored vehicle or the relative positional relationship with the subject vehicle M by causing the HMI 70 to display various images and output sound.

The vehicle control system 100 in the embodiment described above includes the HMI 70 that outputs various information, the outside world recognition unit 142 that recognizes the nearby vehicles traveling around the subject vehicle M, the trajectory generation unit 146 that generates the trajectory on the basis of the relative positional relationship between at least some of the nearby vehicles M recognized by the outside world recognition unit 142 and the subject vehicle M, the travel control unit 160 that controls the acceleration/deceleration or the steering of the subject vehicle M on the basis of the trajectory generated by the trajectory generation unit 146, the specifying unit 146B that specifies, as the monitored vehicle, the nearby vehicle likely to influence the acceleration/deceleration or the steering of the subject vehicle among the nearby vehicles recognized by the outside world recognition unit 142, and the HMI control unit 170 that causes the HMI 70 to output at least information on the presence of the monitored vehicle specified by the specifying unit 146B. Thus, it is possible to inform the vehicle occupant of the surrounding situation of the subject vehicle in an appropriate range.

### Another Embodiment

Hereinafter, another embodiment (modification example) will be described. When a road division line is recognized by the outside world recognition unit 142, the specifying unit 146B in the other embodiment specifies a merging point or a branching point in front of the vehicle M on the basis of a pattern of the road division line. When the merging point or the branching point is specified by the specifying unit 146B, the HMI control unit 170 determines, for example, the second display aspect and causes the display 82 to display a second image in which a position of the merging point or the branching point is indicated.

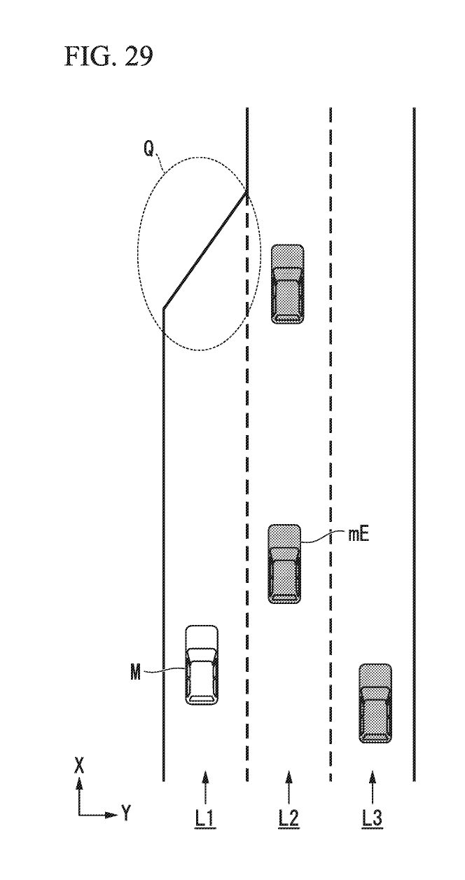

FIG. 29 is a diagram illustrating an example of a scene in which a merging point is present in front of the subject vehicle M. In FIG. 29, Q indicates an area in which a vehicle width of a subject lane L1 decreases and the subject lane L1 disappears. When the above-described area B is specified from the recognition result of the outside world recognition unit 142, the specifying unit 146B determines that the merging point is present in front of the subject vehicle M. In this case, since the trajectory generation unit 146 generates a trajectory for causing the subject vehicle M to change the lane into an adjacent lane L2, the HMI control unit 170 causes the display 82 to display information indicating how many meters the merging point specified by the specifying unit 146B is located ahead, together with this trajectory, as the second image.

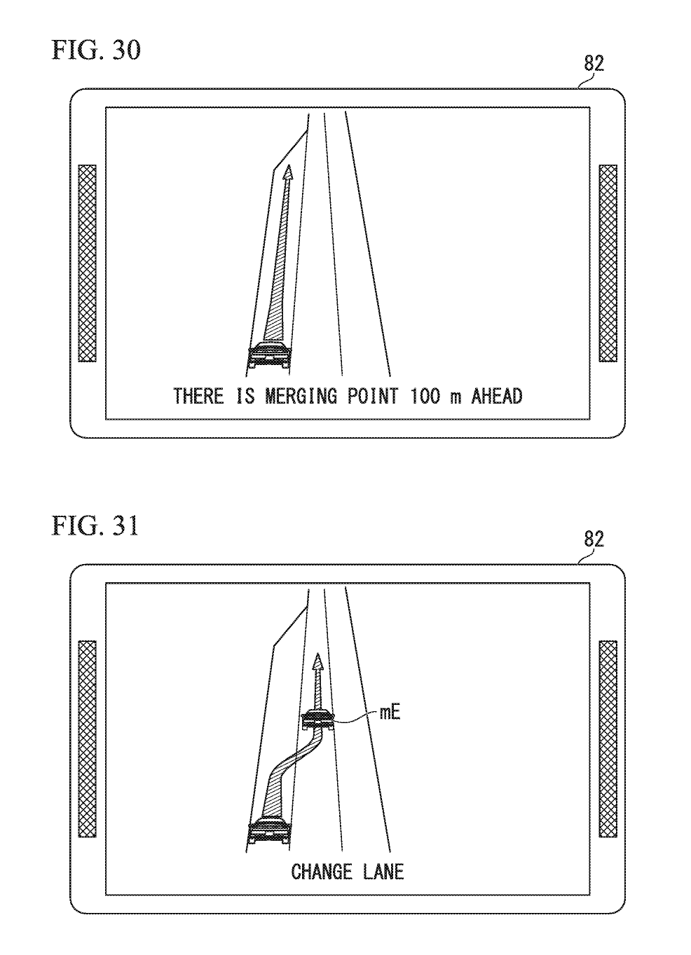

FIGS. 30 and 31 are examples of the second image that is displayed when the merging point is specified by the specifying unit 146B. As illustrated in FIG. 31, the HMI control unit 170 may express a nearby vehicle (in this case, a vehicle mE) which is considered when the subject vehicle M is caused to change the lane into the adjacent lane L2, as a dimensional shape model on a road plane on the second image.

Further, when the display 82 is an instrument panel, the HMI control unit 170 in the other embodiment may cause the various images described above to be displayed on the instrument panel.

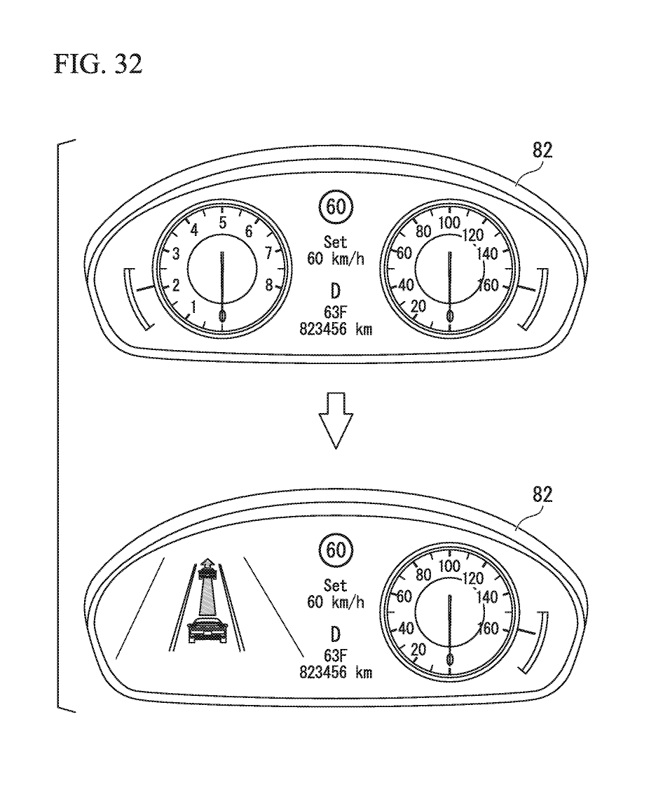

FIG. 32 is a diagram illustrating an example of an image displayed on the instrument panel. For example, the HMI control unit 170 causes a speed meter displaying a speed output by the subject vehicle M, a tachometer displaying a rotation speed of the engine, a fuel gauge, a thermometer, and the like to be displayed in a situation in which the monitored vehicle is not specified by the specifying unit 146B. When the monitored vehicle is specified by the specifying unit 146B, the HMI control unit 170 replaces some or all of the various displayed meters with a first image, a second image, or the like. Accordingly, it is possible to inform the vehicle occupant of the surrounding situation of the subject vehicle in an appropriate range, similar to the above-described embodiment.

Although the modes for carrying out the present invention have been described above by way of embodiments, the present invention is not limited to the embodiments at all, and various modifications and substitutions may be made without departing from the spirit of the present invention.

### REFERENCE SIGNS LIST

20 Finder

30 Radar

40 Camera

DD Detection device

50 Navigation device

60 Vehicle sensor

70 HMI

100 Vehicle control system

110 Target lane determination unit

120 Automated operation control unit

130 Automated driving mode control unit

140 Subject-vehicle position recognition unit

142 Outside world recognition unit

144 Action plan generation unit

146 Trajectory generation unit

146A Traveling aspect determination unit

146B Specifying unit

146C Trajectory candidate generation unit

146D Evaluation and selection unit

150 Switching control unit

160 Travel control unit

170 HMI control unit

180 Storage

200 Travel driving force output device

210 Steering device

220 Brake device

M Subject vehicle

What is claim is:

1-18. (canceled)

19. A vehicle control system comprising:
an output unit that outputs information;
a recognition unit that recognizes nearby vehicles traveling around a subject vehicle;
an action plan generation unit that sets a predetermined event in a section in which the subject vehicle is scheduled to travel;
a control unit that controls acceleration/deceleration or steering of the subject vehicle on the basis of at least some of the nearby vehicles recognized by the recognition unit and the subject vehicle and the event set by the action plan generation unit;
a specifying unit that specifies a nearby vehicle likely to cause a change in the event set by the action plan generation unit among the nearby vehicles recognized by the recognition unit; and
an output control unit that causes the output unit to output at least information on the presence of the nearby vehicle specified by the specifying unit.

20. The vehicle control system according to claim 19,
wherein the output unit displays the information so that an occupant of the subject vehicle can visually recognize the information, and
the output control unit causes the output unit to display the presence of the nearby vehicle specified by the specifying unit in a state in which the relative positional relationship with the subject vehicle is maintained.

21. The vehicle control system according to claim 19, wherein the specifying unit specifies a nearby vehicle approaching the subject vehicle among the nearby vehicles recognized by the recognition unit, as the nearby vehicle likely to cause a change in the event.

22. The vehicle control system according to claim 19, wherein the specifying unit specifies a nearby vehicle of which a time based on a relative position and speed relative to the subject vehicle is equal to or greater than a threshold value among the nearby vehicles recognized by the recognition unit, as the nearby vehicle likely to cause a change in the event.

23. The vehicle control system according to claim 19, wherein the specifying unit specifies a nearby vehicle on the basis of a priority according to a condition for specifying each nearby vehicle when a plurality of nearby vehicles likely to cause a change in the event are specified.

24. The vehicle control system according to claim 23, wherein the priority is set to be higher for a nearby vehicle present on a traveling path of the subject vehicle or a nearby vehicle directed to the subject vehicle.

25. The vehicle control system according to claim 19,
wherein the control unit generates a trajectory of the subject vehicle on the basis of a relative positional relationship between the nearby vehicle recognized by the recognition unit and the subject vehicle, and controls the acceleration/deceleration or the steering of the vehicle on the basis of the generated trajectory, and
the specifying unit specifies a nearby vehicle traveling near the trajectory generated by the control unit among the nearby vehicles recognized by the recognition unit, as the nearby vehicle likely to cause a change in the event.

26. The vehicle control system according to claim 25, wherein the output control unit may further cause the output unit to output information on the trajectory generated by the control unit.

27. The vehicle control system according to claim 19, wherein the output control unit causes the output unit to output the information on the presence of the nearby vehicle specified by the specifying unit when the nearby vehicle specified by the specifying unit is within a predetermined distance in a traveling direction of the subject vehicle with reference to the subject vehicle.

28. The vehicle control system according to claim 19, wherein the output control unit causes the output unit to output the information on the presence of the nearby vehicle specified by the specifying unit in an output aspect different from an output aspect in a case in which the nearby vehicle is within a predetermined distance in a traveling direction of the subject vehicle, when the nearby vehicle specified by the specifying unit is not within the predetermined distance in the traveling direction of the subject vehicle with reference to the subject vehicle.

29. The vehicle control system according to claim 28, wherein the output control unit causes the output unit
to output a first image obtained in a case in which the nearby vehicle specified by the specifying unit is imaged from a first viewpoint behind the subject vehicle, when the nearby vehicle specified by the specifying unit is within the predetermined distance in the traveling direction of the subject vehicle with reference to the subject vehicle, and
to output a second image obtained in a case in which the nearby vehicle specified by the specifying unit is imaged from a second viewpoint located behind the subject vehicle relative to the first viewpoint, when the nearby vehicle specified by the specifying unit is not within the predetermined distance in the traveling direction of the subject vehicle with reference to the subject vehicle.

30. The vehicle control system according to claim 29, further comprising an operation unit that receives an operation from an occupant of the vehicle,
wherein the output control unit switches between the first image and the second image according to an operation received by the operation unit.

31. The vehicle control system according to claim 19, wherein the output control unit further causes the output unit to output information on content of control performed by the control unit in which an influence of the nearby vehicle specified by the specifying unit is reflected.

32. The vehicle control system according to claim 31, wherein the output control unit causes the output unit to output information on content of control performed by the control unit continuously after causing the output unit to output the information on the presence of the nearby vehicle specified by the specifying unit.

33. The vehicle control system according to claim 19, wherein the output unit informs of the information so that an occupant of the subject vehicle can recognize the information.

34. A vehicle control system comprising:
an output unit that outputs information;
an action plan generation unit that sets a predetermined event in a section in which the subject vehicle is scheduled to travel;
a recognition unit that recognizes nearby vehicles traveling around the subject vehicle;
a control unit that controls acceleration/deceleration or steering of the subject vehicle on the basis of at least some of the nearby vehicles recognized by the recognition unit and the event set by the action plan generation unit;
a specifying unit that specifies a nearby vehicle causing a change in the event set by the action plan generation unit among the nearby vehicles recognized by the recognition unit; and
an output control unit that causes the output unit to output at least information on the presence of the nearby vehicle specified by the specifying unit.

35. The vehicle control system according to claim 34, wherein the output unit informs of the information so that an occupant of the subject vehicle can recognize the information.

36. A vehicle control method comprising:
recognizing, by an in-vehicle computer, nearby vehicles traveling around a subject vehicle;
setting, by the in-vehicle computer, a predetermined event in a section in which the subject vehicle is scheduled to travel;
controlling, by the in-vehicle computer, acceleration/deceleration or steering of the subject vehicle on the basis of at least some of the recognized nearby vehicles and the event set by the action plan generation unit;
specifying, by the in-vehicle computer, a nearby vehicle likely to cause a change in the event set by the action plan generation unit among the recognized nearby vehicles; and
causing, by the in-vehicle computer, an output unit outputting information to output at least information on the presence of the specified nearby vehicle.
